(19) United States
(12) Patent Application Publication
(10) Pub. No.: US 2023/0095903 A1
(43) Pub. Date: Mar. 30, 2023

(54) POWER SUPPLY UNIT FOR AEROSOL GENERATION DEVICE

(71) Applicant: JAPAN TOBACCO INC., Tokyo (JP)

(72) Inventors: Yutaka KAIHATSU, Tokyo (JP); Hirofumi FUJIKURA, Tokyo (JP); Takuma NAKANO, Tokyo (JP); Keiji MARUBASHI, Tokyo (JP); Ikuo FUJINAGA, Tokyo (JP); Hajime FUJITA, Tokyo (JP)

(73) Assignee: JAPAN TOBACCO INC., Tokyo (JP)

(21) Appl. No.: 18/070,772

(22) Filed: Nov. 29, 2022

Related U.S. Application Data
(63) Continuation of application No. PCT/JP2021/026028, filed on Jul. 9, 2021.

(30) Foreign Application Priority Data
Nov. 20, 2020 (JP) 2020-193901

(51) Int. Cl. A24F 40/53; A24F 40/10; A24F 40/20; A24F 40/30; A24F 40/60; A24F 40/57

(52) U.S. Cl. CPC A24F 40/53; A24F 40/10; A24F 40/20; A24F 40/30; A24F 40/60; A24F 40/57

(57) ABSTRACT

A power supply unit for an aerosol generation device includes a notification unit and a controller. The controller is configured to execute flavor information acquisition processing of acquiring information on whether an aerosol source and a flavor source contain menthol respectively. The controller is configured execute the flavor information acquisition processing when at least one of a change from a state in which a first load is not connected to a first connector to a state in which the first load is connected to the first connector and a change from a state in which the second load is not capable of heating the flavor source to a state in which the second load is capable of heating the flavor source is detected.

### CROSS REFERENCE TO RELATED APPLICATIONS

This application is a continuation of International Patent Application No. PCT/JP2021/026028 filed on Jul. 9, 2021, claiming priority to Japanese Patent Application No. 2020-193901 filed on Nov. 20, 2020, the content of which is incorporated herein by reference.

### TECHNICAL FIELD

The present invention relates to a power supply unit for an aerosol generation device.

### BACKGROUND ART

JP2019-150031A discloses an aerosol delivery system 100 (an aerosol generation device) that generates an aerosol by vaporizing and/or atomizing an aerosol source by heating the aerosol source. In the aerosol delivery system according to JP2019-150031A, the generated aerosol flows through a second aerosol generation device 400 (an accommodation chamber) that accommodates an aerosol generation element 425 (a flavor source), whereby a flavor component contained in the flavor source is added to the aerosol, and a user can inhale the aerosol containing the flavor component.

The aerosol delivery system described in JP2019-150031A includes a reservoir substrate 214, a space (a heating chamber) that accommodates a liquid transport element 238 and a heat generating element 240, and the second aerosol generation device 400 (an accommodation chamber) that accommodates the aerosol generation element 425. An aerosol precursor composition is stored in the reservoir substrate 214. The liquid transport element 238 transports and holds the aerosol precursor composition from the reservoir substrate 214 to the heating chamber. The aerosol precursor composition held by the liquid transport element 238 is heated by the heat generating element 240 to be aerosolized, passes through the aerosol generation element 425 of the second aerosol generation device 400, is added with the flavor component, and is then supplied to the user.

In addition, JP2019-150031A discloses that menthol may be contained in both the aerosol precursor composition of the reservoir substrate 214 and the aerosol generation element of the second aerosol generation device 400.

In a similar manner to cigarette smokers, users of an aerosol generation device also have various flavor tastes preferred by the users. For example, among users who use an aerosol generation device, there are users who prefer the flavor of menthol and users who prefer the regular flavor that does not contain menthol. In order to cope with the users having different preference, it is desired that an aerosol generation device can select a plurality of types of aerosol sources and/or flavor sources, and can generate an aerosol added with a plurality of types of flavors. Further, in order to provide the user with the optimum flavor, it is preferable to separately set a mode for controlling discharging to a load for heating an aerosol source and/or a flavor source in accordance with the selected aerosol source and/or the flavor source, but for this purpose, it is necessary to identify flavor types of the aerosol source and the flavor source, such as whether menthol is contained. In this case, in order to execute the flavor identification processing for identifying the flavor types of the aerosol source and the flavor source, there is a problem that power consumption of a power supply increases.

An object of the present invention is to provide an aerosol generation device in which power consumption of a power supply is saved and flavor identification processing is improved.

### SUMMARY OF INVENTION

According to an aspect of the present invention, there is provided a power supply unit for an aerosol generation device including a first connector electrically connectable, in an attachable and detachable manner, to a first load configured to heat an aerosol source, a second connector electrically connectable, in an attachable and detachable manner, to a second load configured to heat a flavor source capable of imparting a flavor to the aerosol source vaporized and/or atomized by being heated with the first load, a power supply electrically connected to the first connector and the second connector, a notification unit configured to notify a user of information, and a controller. The controller is configured to detect whether the first load is connected to the first connector, detect whether the second load is in a state of being capable of heating the flavor source, execute flavor information acquisition processing of acquiring information on whether the aerosol source and the flavor source contain menthol respectively, control at least one of the notification unit and discharging from the power supply to the first load and the second load based on a result of the flavor information acquisition processing, and execute the flavor information acquisition processing when at least one of a change from a state in which the first load is not connected to the first connector to a state in which the first load is connected to the first connector and a change from a state in which the second load is not capable of heating the flavor source to a state in which the second load is capable of heating the flavor source is detected.

### BRIEF DESCRIPTION OF DRAWINGS

FIG. 1 is a perspective view schematically showing a schematic configuration of an aerosol inhaler.

FIG. 2 is another perspective view of the aerosol inhaler in FIG. 1.

FIG. 3 is a cross-sectional view of the aerosol inhaler in FIG. 1.

FIG. 4 is a perspective view of a power supply unit in the aerosol inhaler in FIG. 1.

FIG. 5 is a diagram showing a state in which a capsule is accommodated in a capsule holder in the aerosol inhaler in FIG. 1.

FIG. 6 is a schematic diagram showing a hardware configuration of the aerosol inhaler in FIG. 1.

FIG. 7 is a diagram showing a specific example of the power supply unit in FIG. 6.

FIG. 8 is a flowchart (part 1) showing an operation of the aerosol inhaler in FIG. 1.

FIG. 9 is a flowchart (part 2) showing the operation of the aerosol inhaler in FIG. 1.

FIG. 10 is a flowchart (part 3) showing the operation of the aerosol inhaler in FIG. 1.

FIG. 11 is a flowchart showing processing contents of flavor identification processing.

FIG. 12 is a flowchart showing processing contents of error mode processing.

FIG. 13 is a diagram (part 1) showing a specific control example in a menthol mode.

FIG. 14 is a diagram (part 2) showing the specific control example in the menthol mode.

### DESCRIPTION OF EMBODIMENTS

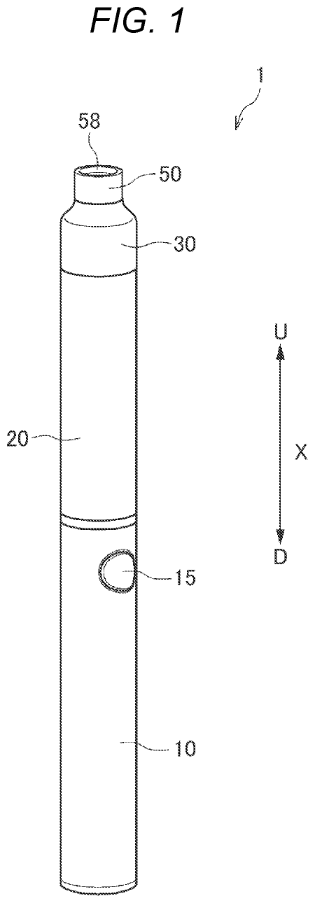

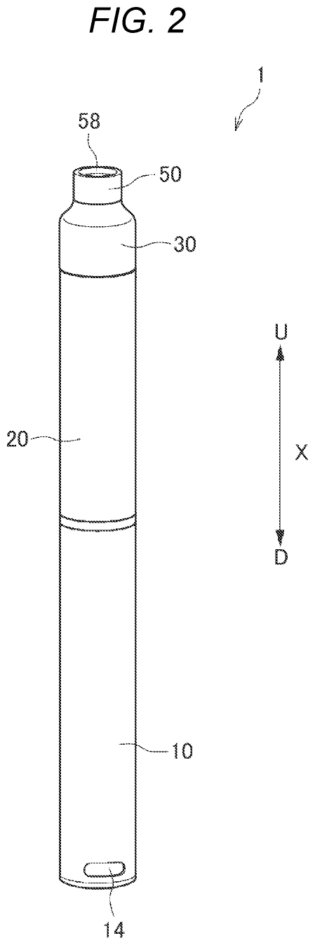

Hereinafter, an aerosol inhaler 1, which is an embodiment of an aerosol generation device of the present invention, will be described with reference to FIGS. 1 to 14. The drawings are viewed in directions of reference numerals.

(Overview of Aerosol Inhaler)

As shown in FIGS. 1 to 3, the aerosol inhaler 1 is an instrument for generating an aerosol without combustion, adding a flavor component to the generated aerosol, and allowing a user to inhale the aerosol containing the flavor component. As an example, the aerosol inhaler 1 has a rod shape.

The aerosol inhaler 1 includes a power supply unit 10, a cartridge cover 20 that accommodates a cartridge 40 in which an aerosol source 71 is stored, and a capsule holder 30 that accommodates a capsule 50 including an accommodation chamber 53 in which a flavor source 52 is accommodated. The power supply unit 10, the cartridge cover 20, and the capsule holder 30 are provided in this order from one end side to the other end side in a longitudinal direction of the aerosol inhaler 1. The power supply unit 10 has a substantially cylindrical shape centered on a center line L extending in the longitudinal direction of the aerosol inhaler 1. The cartridge cover 20 and the capsule holder 30 have a substantially annular shape centered on the center line L extending in the longitudinal direction of the aerosol inhaler 1. An outer peripheral surface of the power supply unit 10 and an outer peripheral surface of the cartridge cover 20 have a substantially annular shape having substantially the same diameter, and the capsule holder 30 has a substantially annular shape having a slightly smaller diameter than the power supply unit 10 and the cartridge cover 20.

Hereinafter, in order to simplify and clarify descriptions in the present description and the like, the longitudinal direction of the rod-shaped aerosol inhaler 1 is defined as a first direction X. In the first direction X, a side of the aerosol inhaler 1 where the power supply unit 10 is disposed is defined as a bottom side, and a side of the aerosol inhaler 1 where the capsule holder 30 is disposed is defined as a top side for convenience. In the drawings, the bottom side of the aerosol inhaler 1 in the first direction X is denoted by D, and the top side of the aerosol inhaler 1 in the first direction X is denoted by U.

The cartridge cover 20 has a hollow and substantially annular shape of which both end surfaces at the bottom side and the top side are opened. The cartridge cover 20 is made of a metal such as stainless steel. An end portion at the bottom side of the cartridge cover 20 is coupled to an end portion at the top side of the power supply unit 10. The cartridge cover 20 is attachable to and detachable from the power supply unit 10. The capsule holder 30 has a hollow and substantially annular shape of which both end surfaces at the bottom side and the top side are opened. An end portion at the bottom side of the capsule holder 30 is coupled to an end portion at the top side of the cartridge cover 20. The capsule holder 30 is made of a metal such as aluminum. The capsule holder 30 is attachable to and detachable from the cartridge cover 20.

The cartridge 40 has a substantially cylindrical shape and is accommodated in the cartridge cover 20. In a state in which the capsule holder 30 is removed from the cartridge cover 20, the cartridge 40 can be accommodated in the cartridge cover 20 and can be taken out from the cartridge cover 20. Therefore, the aerosol inhaler 1 can be used in a manner of replacing the cartridge 40.

The capsule 50 has a substantially cylindrical shape, and is accommodated in a hollow portion of the capsule holder 30 that has a hollow and substantially annular shape such that an end portion at the top side of the capsule 50 in the first direction X is exposed in the first direction X from an end portion at the top side of the capsule holder 30. The capsule 50 is attachable to and detachable from the capsule holder 30. Therefore, the aerosol inhaler 1 can be used in a manner of replacing the capsule 50.

(Power Supply Unit)

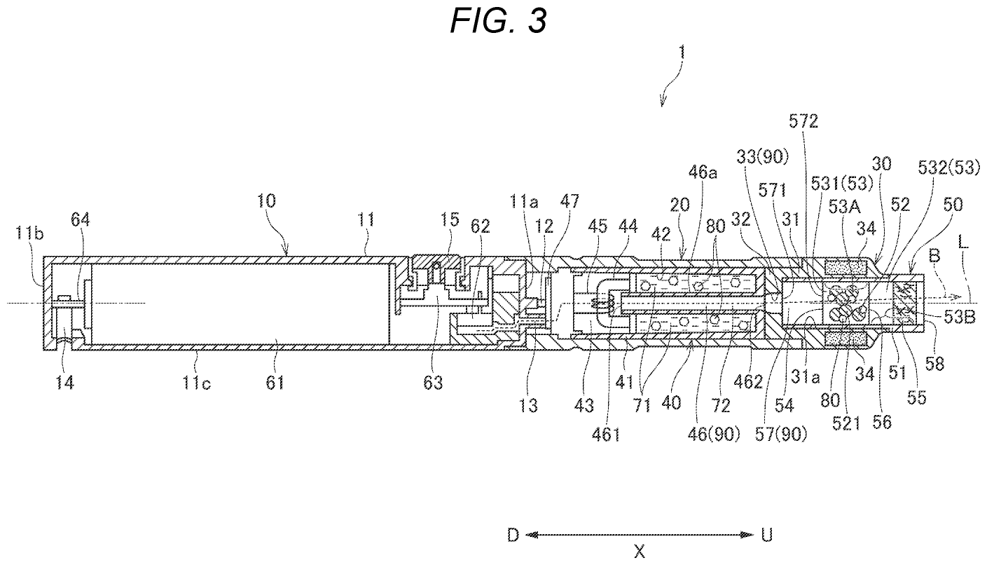

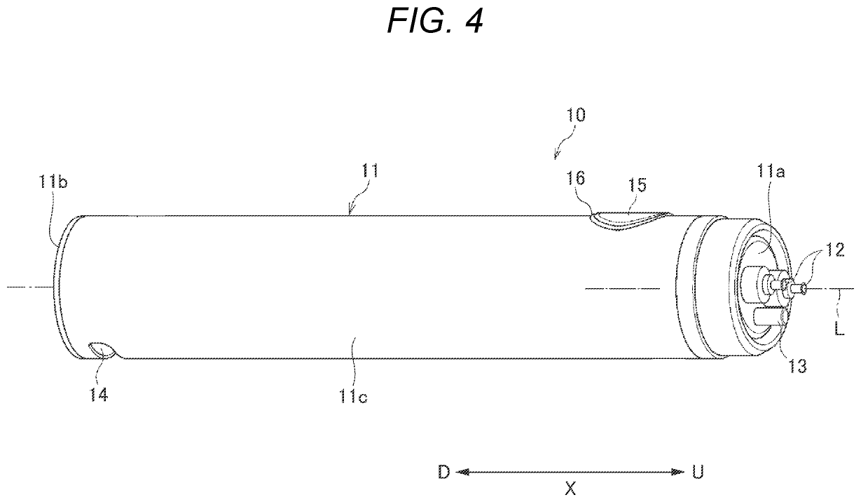

As shown in FIGS. 3 and 4, the power supply unit 10 includes a power supply unit case 11 that has a hollow and substantially annular shape and is centered on the center line L extending in the first direction X. The power supply unit case 11 is made of a metal such as stainless steel. The power supply unit case 11 includes a top surface 11a which is an end surface at the top side of the power supply unit case 11 in the first direction X, a bottom surface 11b which is an end surface at the bottom side of the power supply unit case 11 in the first direction X, and a side surface 11c which extends in the first direction X in a substantially annular shape centered on the center line L from the top surface 11a to the bottom surface 11b.

Discharge terminals 12 are provided on the top surface 11a of the power supply unit case 11. The discharge terminals 12 protrude from the top surface 11a of the power supply unit case 11 toward the top side in the first direction X.

An air supply portion 13 that supplies air to a heating chamber 43 of the cartridge 40 to be described later is provided on the top surface 11a in the vicinity of the discharge terminals 12. The air supply portion 13 protrudes from the top surface 11a of the power supply unit case 11 toward the top side in the first direction X.

A charging terminal 14 that can be electrically connected to an external power supply (not shown) is provided on the side surface 11c of the power supply unit case 11. In the present embodiment, the charging terminal 14 is provided on the side surface 11c in the vicinity of the bottom surface 11b, and is, for example, a receptacle that can be connected to a universal serial bus (USB) terminal, a micro USB terminal, or the like.

The charging terminal 14 may be a power receiving unit that can receive power transmitted from the external power supply in a wireless manner. In such a case, the charging terminal 14 (a power receiving unit) may be implemented by a power receiving coil. A wireless power transfer (WPT) system may be of an electromagnetic induction type, a magnetic resonance type, or a combination of an electromagnetic induction type and a magnetic resonance type. Further, the charging terminal 14 may be a power receiving unit that can receive power transmitted from an external power supply without contact. As another example, the charging terminal 14 may include both the power receiving unit described above and the receptacle that can be connected to a USB terminal, a micro USB terminal, or the like.

An operation unit 15 that can be operated by the user is provided on the side surface 11c of the power supply unit case 11. The operation unit 15 is provided on the side surface 11c in the vicinity of the top surface 11a. In the present embodiment, the operation unit 15 is provided at a position about 180 degrees away from the charging terminal 14 centered on the center line L when viewed from the first direction X. In the present embodiment, the operation unit 15 is a push button type switch having a circular shape when the side surface 11c of the power supply unit case 11 is viewed from the outside. The operation unit 15 may have a shape other than the circular shape, or may be implemented by a switch other than a push button type switch, a touch panel, or the like.

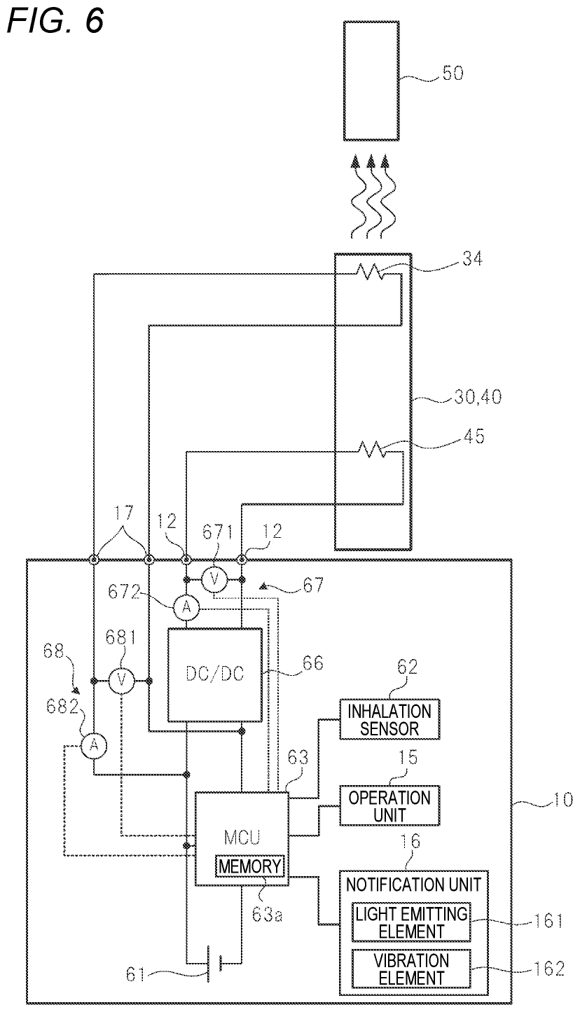

The power supply unit case 11 is provided with a notification unit 16 that notifies various kinds of information. The notification unit 16 includes a light emitting element 161 and a vibration element 162 (see FIG. 6). In the present embodiment, the light emitting element 161 is provided inward of the operation unit 15 on the power supply unit case 11. A periphery of the circular operation unit 15 is translucent when the side surface 11c of the power supply unit case 11 is viewed from the outside, and light is emitted by the light emitting element 161. In the present embodiment, the light emitting element 161 can emit red light, green light, blue light, white light, and purple light.

The power supply unit case 11 is provided with an air intake port (not shown) through which outside air is taken into the power supply unit case 11. The air intake port may be provided around the charging terminal 14, may be provided around the operation unit 15, or may be provided in the power supply unit case 11 at a position away from the charging terminal 14 and the operation unit 15. The air intake port may be provided in the cartridge cover 20. The air intake port may be provided at two or more positions of the above-described positions.

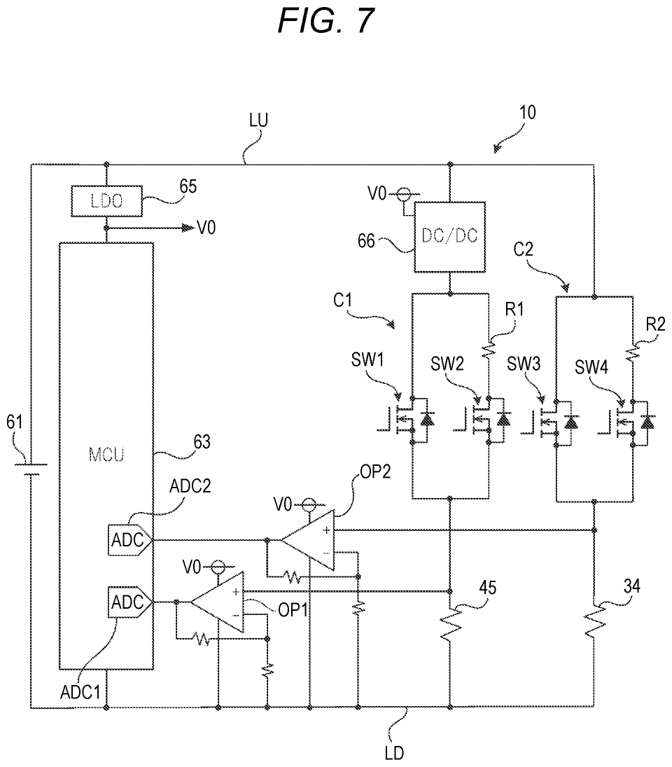

A power supply 61, an inhalation sensor 62, a micro controller unit (MCU) 63, and a charging integrated circuit (IC) 64 are accommodated in a hollow portion of the power supply unit case 11 that has a hollow and substantially annular shape. A low drop out (LDO) regulator 65, a DC/DC converter 66, a first temperature detection element 67 including a voltage sensor 671 and a current sensor 672, and a second temperature detection element 68 including a voltage sensor 681 and a current sensor 682 are further accommodated in the power supply unit case 11 (see FIGS. 6 and 7).

The power supply 61 is a chargeable and dischargeable power storage device such as a secondary battery or an electric double layer capacitor, and is preferably a lithium ion secondary battery. An electrolyte of the power supply 61 may be formed of one or a combination of a gel-like electrolyte, an electrolytic solution, a solid electrolyte, and an ionic liquid.

The inhalation sensor 62 is provided in the vicinity of the operation unit 15. The inhalation sensor 62 is a pressure sensor that detects a puff (inhaling) operation. The inhalation sensor 62 outputs a value of a change in a pressure (internal pressure) inside the power supply unit 10 caused by an inhalation of the user through an inhalation port 58 of the capsule 50 to be described later. For example, the inhalation sensor 62 outputs an output value (for example, a voltage value or a current value) corresponding to the internal pressure that changes according to a flow rate of air inhaled from the air intake port toward the inhalation port 58 of the capsule 50 (that is, an inhaling operation of the user). The inhalation sensor 62 may output an analog value, or may output a digital value converted from the analog value.

In order to compensate for a pressure to be detected, the inhalation sensor 62 may include a temperature sensor that detects a temperature (an outside air temperature) of an environment in which the power supply unit 10 is placed. The inhalation sensor 62 may be implemented by a condenser microphone, a flow rate sensor, or the like, instead of a pressure sensor.

The MCU 63 is an electronic component that performs various controls of the aerosol inhaler 1. Specifically, the MCU 63 is mainly implemented by a processor, and further includes a memory 63a implemented by a storage medium such as a random access memory (RAM) necessary for an operation of the processor and a read only memory (ROM) that stores various kinds of information (see FIG. 6). Specifically, the processor in the present description is an electric circuit in which circuit elements such as semiconductor elements are combined.

When a puff operation is performed and an output value of the inhalation sensor 62 exceeds a threshold, the MCU 63 determines that an aerosol generation request is made, and thereafter, when the output value of the inhalation sensor 62 falls below the threshold, the MCU 63 determines that the aerosol generation request is ended. In this way, the output value of the inhalation sensor 62 is used as a signal indicating an aerosol generation request. Therefore, the inhalation sensor 62 constitutes a sensor that outputs an aerosol generation request. Instead of the MCU 63, the inhalation sensor 62 may perform the above-described determination, and the MCU 63 may receive a digital value corresponding to a determination result from the inhalation sensor 62. As a specific example, the inhalation sensor 62 may output a high-level signal when it is determined that an aerosol generation request is made, and the inhalation sensor 62 may output a low-level signal when it is determined that an aerosol generation request is ended. The threshold for the MCU 63 or the inhalation sensor 62 to determine that the aerosol generation request is made may be different from the threshold for the MCU 63 or the inhalation sensor 62 to determine that the aerosol generation request is ended.

Instead of the inhalation sensor 62, the MCU 63 may detect the aerosol generation request based on an operation of the operation unit 15. For example, when the user performs a predetermined operation on the operation unit 15 in order to start inhalation of aerosol, the operation unit 15 may output a signal indicating an aerosol generation request to the MCU 63. In this case, the operation unit 15 constitutes a sensor that outputs an aerosol generation request.

The charging IC 64 is provided in the vicinity of the charging terminal 14. The charging IC 64 controls the charging of the power supply 61 by controlling power input from the charging terminal 14 to charge the power supply 61. The charging IC 64 may be disposed in the vicinity of the MCU 63.

(Cartridge)

As shown in FIG. 3, the cartridge 40 includes a cartridge case 41 having a substantially cylindrical shape whose axial direction is a longitudinal direction. The cartridge case 41 is made of a resin such as polycarbonate. A storage chamber 42 that stores the aerosol source 71 and the heating chamber 43 that heats the aerosol source 71 are formed inside the cartridge case 41. The heating chamber 43 accommodates a wick 44 that transports the aerosol source 71 stored in the storage chamber 42 to the heating chamber 43 and holds the aerosol source 71 in the heating chamber 43, and a first load 45 that heats the aerosol source 71 held in the wick 44 to vaporize and/or atomize the aerosol source 71. The cartridge 40 further includes a first aerosol flow path 46 through which the aerosol source 71 that is vaporized and/or atomized by being heated with the first load 45 is aerosolized and then is transported from the heating chamber 43 toward the capsule 50.

The storage chamber 42 and the heating chamber 43 are formed adjacent to each other in the longitudinal direction of the cartridge 40. The heating chamber 43 is formed on one end side in the longitudinal direction of the cartridge 40, and the storage chamber 42 is formed to be adjacent to the heating chamber 43 in the longitudinal direction of the cartridge 40 and to extend to an end portion on the other end side in the longitudinal direction of the cartridge 40. A connection terminal 47 is provided on an end surface on one end side in the longitudinal direction of the cartridge case 41, that is, an end surface of the cartridge case 41 on a side where the heating chamber 43 is disposed, in the longitudinal direction of the cartridge 40.

The storage chamber 42 has a hollow and substantially annular shape whose axial direction is the longitudinal direction of the cartridge 40, and stores the aerosol source 71 in an annular portion. The storage chamber 42 accommodates a porous body such as a resin web or cotton, and the aerosol source 71 may be impregnated in the porous body. The storage chamber 42 may store only the aerosol source 71 without accommodating the porous body such as a resin web or cotton. The aerosol source 71 contains a liquid such as glycerin and/or propylene glycol. Further, the aerosol source 71 contains menthol 80. In FIG. 3, the menthol 80 is shown in a form of particles in order to facilitate understanding of the description, but in the present embodiment, the menthol 80 is dissolved in a liquid such as glycerin and/or propylene glycol. It should be noted that the menthol 80 shown in FIG. 3 and the like is merely a simulation, and positions and quantity of the menthol 80 in the storage chamber 42, positions and quantity of the menthol 80 in the capsule 50, and a positional relationship between the menthol 80 and the flavor source 52 do not necessarily coincide with actual ones.

The wick 44 is a liquid holding member that draws the aerosol source 71 stored in the storage chamber 42 from the storage chamber 42 into the heating chamber 43 using a capillary action and holds the aerosol source 71 in the heating chamber 43. The wick 44 is made of, for example, glass fiber or porous ceramic. The wick 44 may extend into the storage chamber 42.

The first load 45 is electrically connected to the connection terminal 47. In the present embodiment, the first load 45 is implemented by an electric heating wire (s coil) wound around the wick 44 at a predetermined pitch. The first load 45 may be an element that can heat the aerosol source 71 held by the wick 44 to vaporize and/or atomize the aerosol source 71. The first load 45 may be, for example, a heat generating element such as a heat generating resistor, a ceramic heater, or an induction heating type heater. As the first load 45, a load whose temperature and electric resistance value have a correlation is used. For example, as the first load 45, a load having a positive temperature coefficient (PTC) characteristic is used in which an electric resistance value increases as the temperature increases. Alternatively, as the first load 45, for example, a load having a negative temperature coefficient (NTC) characteristic may be used in which an electric resistance value decreases as the temperature increases. A part of the first load 45 may be provided outside the heating chamber 43.

The first aerosol flow path 46 is formed in a hollow portion of the storage chamber 42 having a hollow and substantially annular shape, and extends in the longitudinal direction of the cartridge 40. The first aerosol flow path 46 is formed by a wall portion 46a that extends in a substantially annular shape in the longitudinal direction of the cartridge 40. The wall portion 46a of the first aerosol flow path 46 is also an inner peripheral side wall portion of the storage chamber 42 having a substantially annular shape. A first end portion 461 of the first aerosol flow path 46 in the longitudinal direction of the cartridge 40 is connected to the heating chamber 43, and a second end portion 462 of the first aerosol flow path 46 in the longitudinal direction of the cartridge 40 is opened to an end surface at the other end side of the cartridge case 41.

The first aerosol flow path 46 is formed such that a cross-sectional area thereof does not change or increases from the first end portion 461 toward the second end portion 462 in the longitudinal direction of the cartridge 40. The cross-sectional area of the first aerosol flow path 46 may increase discontinuously from the first end portion 461 toward the second end portion 462, or may increase continuously as shown in FIG. 3.

The cartridge 40 is accommodated in a hollow portion of the cartridge cover 20 having a hollow and substantially annular shape such that the longitudinal direction of the cartridge 40 is the first direction X which is the longitudinal direction of the aerosol inhaler 1. Further, the cartridge 40 is accommodated in the hollow portion of the cartridge cover 20 such that the heating chamber 43 is at the bottom side of the aerosol inhaler 1 (that is, at a power supply unit 10 side) and the storage chamber 42 is at the top side of the aerosol inhaler 1 (that is, at a capsule 50 side) in the first direction X.

The first aerosol flow path 46 of the cartridge 40 extends in the first direction X on the center line L of the aerosol inhaler 1 in a state in which the cartridge 40 is accommodated inside the cartridge cover 20.

When the aerosol inhaler 1 is in use, the cartridge 40 is accommodated in the hollow portion of the cartridge cover 20 so as to maintain a state in which the connection terminal 47 comes into contact with the discharge terminals 12 provided on the top surface 11a of the power supply unit case 11. When the discharge terminals 12 of the power supply unit 10 and the connection terminal 47 of the cartridge 40 come into contact with each other, the first load 45 of the cartridge 40 is electrically connected to the power supply 61 of the power supply unit 10 via the discharge terminals 12 and the connection terminal 47.

Further, when the aerosol inhaler 1 is in use, the cartridge 40 is accommodated in the hollow portion of the cartridge cover 20 such that air flowing in from the air intake port (not shown) provided in the power supply unit case 11 is taken into the heating chamber 43 from the air supply portion 13 provided on the top surface 11a of the power supply unit case 11 as indicated by an arrow B in FIG. 3. The arrow B is inclined with respect to the center line L in FIG. 3, and may be in the same direction as the center line L. In other words, the arrow B may be parallel to the center line L.

When the aerosol inhaler 1 is in use, the first load 45 heats the aerosol source 71 held by the wick 44 without combustion using power supplied from the power supply 61 via the discharge terminals 12 provided in the power supply unit case 11 and the connection terminal 47 provided in the cartridge 40. In the heating chamber 43, the aerosol source 71 heated by the first load 45 is vaporized and/or atomized. In this case, the vaporized and/or atomized aerosol source 71 contains vaporized and/or atomized menthol 80 and vaporized and/or atomized glycerin and/or propylene glycol.

The aerosol source 71 vaporized and/or atomized in the heating chamber 43 aerosolizes air taken into the heating chamber 43 from the air supply portion 13 of the power supply unit case 11 as a dispersion medium. Further, the aerosol source 71 vaporized and/or atomized in the heating chamber 43 and the air taken into the heating chamber 43 from the air supply portion 13 of the power supply unit case 11 flow through the first aerosol flow path 46 from the first end portion 461 of the first aerosol flow path 46 communicating with the heating chamber 43 to the second end portion 462 of the first aerosol flow path 46, while being further aerosolized. A temperature of the aerosol source 71 vaporized and/or atomized in the heating chamber 43 decreases in the process of flowing through the first aerosol flow path 46, which promotes aerosolization. In this way, the aerosol source 71 vaporized and/or atomized in the heating chamber 43 and the air taken into the heating chamber 43 from the air supply portion 13 of the power supply unit case 11 are used to generate aerosol 72 in the heating chamber 43 and the first aerosol flow path 46. The aerosol 72 in the heating chamber 43 and the first aerosol flow path 46 also contains the menthol 80 that is aerosolized and derived from the aerosol source 71.

(Capsule Holder)

The capsule holder 30 includes a side wall 31 extending in the first direction X in a substantially annular shape, and has a hollow and substantially annular shape of which both end surfaces at the bottom side and the top side are opened. The side wall 31 is formed of a metal such as aluminum. An end portion at the bottom side of the capsule holder 30 is coupled to an end portion at the top side of the cartridge cover 20 by screwing, locking, or the like, and the capsule holder 30 is attachable to and detachable from the cartridge cover 20. An inner peripheral surface 31a of the side wall 31 having a substantially annular shape has an annular shape centered on the center line L of the aerosol inhaler 1, and has a diameter larger than that of the first aerosol flow path 46 of the cartridge 40 and smaller than that of the cartridge cover 20.

The capsule holder 30 includes a bottom wall 32 provided at an end portion at the bottom side of the side wall 31. The bottom wall 32 is made of, for example, a resin. The bottom wall 32 is fixed to the end portion at the bottom side of the side wall 31, and closes a hollow portion surrounded by an inner peripheral surface of the side wall 31 at the end portion at the bottom side of the side wall 31 except for a communication hole 33 to be described later.

The bottom wall 32 is provided with the communication hole 33 penetrating the bottom wall 32 in the first direction X. The communication hole 33 is formed at a position overlapping the center line L when viewed from the first direction. In a state in which the cartridge 40 is accommodated in the cartridge cover 20 and the capsule holder 30 is mounted on the cartridge cover 20, the communication hole 33 is formed such that the first aerosol flow path 46 of the cartridge 40 is located inside the communication hole 33 when viewed from the top side in the first direction X.

A second load 34 may be provided on the side wall 31 of the capsule holder 30. The second load 34 may be provided at a position separated from both the end portion on the bottom side and the end portion on the top side of the side wall 31. The second load 34 may be provided at the bottom side of the side wall 31. In other words, the second load 34 may not be provided at the top side of the side wall 31 in contact with the capsule 50. The second load 34 has an annular shape along the substantially annular side wall 31, and extends in the first direction X. The second load 34 heats the storage chamber 53 of the capsule 50 to heat the flavor source 52 accommodated in the accommodation chamber 53. The second load 34 may be an element that can heat the flavor source 52 by heating the accommodation chamber 53 of the capsule 50. The second load 34 may be, for example, a heat generating element such as a heat generating resistor, a ceramic heater, or an induction heating type heater. As the second load 34, a load whose temperature and electric resistance value have a correlation is used. For example, as the second load 34, a load having a positive temperature coefficient (PTC) characteristic is used in which an electric resistance value increases as the temperature increases. Alternatively, as the second load 34, for example, a load having a negative temperature coefficient (NTC) characteristic may be used in which an electric resistance value decreases as the temperature increases.

In a state in which the cartridge cover 20 is mounted on the power supply unit 10 and the capsule holder 30 is mounted on the cartridge cover 20, the second load 34 is electrically connected to the power supply 61 of the power supply unit 10 (see FIGS. 6 and 7). Specifically, when the cartridge cover 20 is mounted on the power supply unit 10 and the capsule holder 30 is mounted on the cartridge cover 20, a discharge terminal 17 (see FIG. 6) of the power supply unit 10 and a connection terminal (not shown) of the capsule holder 30 come into contact with each other, whereby the second load 34 of the capsule holder 30 is electrically connected to the power supply 61 of the power supply unit 10 via the discharge terminal 17 and the connection terminal of the capsule holder 30.

(Capsule)

The capsule 50 has a substantially cylindrical shape and includes a side wall 51 which is opened at both end surfaces and extends in a substantially annular shape. The side wall 51 is made of a resin such as plastic. The side wall 51 has a substantially annular shape having a diameter slightly smaller than that of the inner peripheral surface 31a of the side wall 31 of the capsule holder 30.

The capsule 50 includes the accommodation chamber 53 that accommodates the flavor source 52. As shown in FIG. 3, the accommodation chamber 53 may be formed in an internal space of the capsule 50 surrounded by the side wall 51. Alternatively, the entire internal space of the capsule 50 excluding an outlet portion 55 to be described later may be the accommodation chamber 53.

The flavor source 52 includes cigarette granules 521 obtained by molding a cigarette raw material into granules. In the present embodiment, the capsule 50 of a regular type that accommodates the flavor source 52 containing no menthol 80 and the capsule 50 of a menthol type that accommodates the flavor source 52 containing the menthol 80 are provided to the user by the manufacturer or the like of the aerosol inhaler 1. In the capsule 50 of a menthol type, for example, the menthol 80 is adsorbed to the cigarette granules 521 constituting the flavor source 52.

The accommodation chamber 53 includes an inlet portion 54 provided at one end side in a cylindrical axis direction of the capsule 50 extending in a substantially cylindrical shape, and the outlet portion 55 provided at the other end side in the cylindrical axis direction of the capsule 50. In the present embodiment, the flavor source 52 includes the menthol 80 and the tobacco granules 521 obtained by molding a tobacco raw material into granules. Specifically, in the flavor source 52, the menthol 80 is adsorbed to the cigarette granules 521. The flavor source 52 may include cut tobacco instead of the cigarette granules 521. In addition, instead of the cigarette granules 521, the flavor source 52 may include a plant (for example, mint, Chinese herb, and herb) other than cigarettes. In addition, the flavor source 52 may be added with another flavor in addition to the menthol 80.

As shown in FIG. 3, when the accommodation chamber 53 is formed in the internal space of the capsule 50, the inlet portion 54 may be a partition wall that partitions the internal space of the capsule 50 in the cylindrical axis direction of the capsule 50 at a position separated from a bottom portion of the capsule 50 in the cylindrical axis direction of the capsule 50. The inlet portion 54 may be a mesh-like partition wall through which the flavor source 52 cannot pass and through which the aerosol 72 can pass.

When the entire internal space of the capsule 50 excluding the outlet portion 55 is the accommodation chamber 53, the bottom portion of the capsule 50 also serves as the inlet portion 54.

The outlet portion 55 is a filter member that is filled in the internal space of the capsule 50 surrounded by the side wall 51 at an end portion at the top side of the side wall 51 in the cylindrical axis direction of the capsule 50. The outlet portion 55 is a filter member through which the flavor source 52 cannot pass and through which the aerosol 72 can pass. In the present embodiment, the outlet portion 55 is provided in the vicinity of a top portion of the capsule 50, but the outlet portion 55 may be provided at a position separated from the top portion of the capsule 50.

The accommodation chamber 53 includes a first space 531 in which the flavor source 52 is present and a second space 532 in which the flavor source 52 is not present, the second space 532 being located between the first space 531 and the outlet portion 55 and being adjacent to the outlet portion 55. In the present embodiment, in the accommodation chamber 53, the first space 531 and the second space 532 are formed adjacent to each other in the cylindrical axis direction of the capsule 50. One end side of the first space 531 in the cylindrical axis direction of the capsule 50 is adjacent to the inlet portion 54, and the other end side of the first space 531 in the cylindrical axis direction of the capsule 50 is adjacent to the second space 532. One end side of the second space 532 in the cylindrical axis direction of the capsule 50 is adjacent to the first space 531, and the other end side of the second space 532 in the cylindrical axis direction of the capsule 50 is adjacent to the outlet portion 55. The first space 531 and the second space 532 may be partitioned by a mesh-like partition wall 56 through which the flavor source 52 cannot pass and through which the aerosol 72 can pass. The first space 531 and the second space 532 may be formed without using such a partition wall 56. As a specific example, the first space 531 and the second space 532 may be formed by accommodating the flavor source 52 in a pressed state in a part of the accommodation chamber 53 and making it difficult for the flavor source 52 to move in the accommodation chamber 53. As another specific example, the first space 531 and the second space 532 may be formed by allowing the flavor source 52 to freely move in the accommodation chamber 53 and moving the flavor source 52 to a bottom side of the accommodation chamber 53 due to gravity when the user performs an inhaling operation through the inhalation port 58.

As shown in FIG. 3, when the accommodation chamber 53 is formed in the internal space of the capsule 50, a second aerosol flow path 57 may be formed in the capsule 50 between the bottom portion of the capsule 50 and the inlet portion 54 in the cylindrical axis direction of the capsule 50.

The second aerosol flow path 57 is formed by the internal space of the capsule 50 surrounded by the side wall 51 between the bottom portion of the capsule 50 and the inlet portion 54 in the cylindrical axis direction of the capsule 50. Therefore, in the second aerosol flow path 57, a first end portion 571 in the cylindrical axis direction of the capsule 50 is opened at the bottom portion of the capsule 50, and a second end portion 572 in the cylindrical axis direction of the capsule 50 is connected to the accommodation chamber 53 at the inlet portion 54 of the accommodation chamber 53.

An opening area of the communication hole 33 provided in the bottom wall 32 of the capsule holder 30 is larger than the cross-sectional area of the first aerosol flow path 46 of the cartridge 40, and a cross-sectional area of the second aerosol flow path 57 is larger than both the cross-sectional area of the first aerosol flow path 46 of the cartridge 40 and the opening area of the communication hole 33 provided in the bottom wall 32 of the capsule holder 30. Therefore, a cross-sectional area of the second end portion 572 of the second aerosol flow path 57 connected to the accommodation chamber 53 of the capsule 50 is larger than a cross-sectional area of the first end portion 461 of the first aerosol flow path 46 connected to the heating chamber 43 of the cartridge 40. An aerosol flow path 90 in the present embodiment includes the first aerosol flow path 46, the communication hole 33, and the second aerosol flow path 57. The cross-sectional area of the first end portion 461 of the first aerosol flow path 46 connected to the heating chamber 43 is smaller than the cross-sectional area of the second end portion 462 of the first aerosol flow path 46 connected to the communication hole 33. The cross-sectional area of the first end portion 461 of the first aerosol flow path 46 connected to the heating chamber 43 is smaller than the cross-sectional area of the communication hole 33. The cross-sectional area of the communication hole 33 is smaller than the cross-sectional area of the second aerosol flow path 57. That is, in the aerosol flow path 90, the cross-sectional area of the second end portion 572 of the second aerosol flow path 57 that constitutes a second end portion connected to the accommodation chamber 53 is larger than the cross-sectional area of the first end portion 461 of the first aerosol flow path 46 that constitutes a first end portion connected to the heating chamber 43. The aerosol flow path 90 is formed such that the cross-sectional area increases from the first end portion toward the second end portion.

When the entire internal space of the capsule 50 excluding the outlet portion 55 is the accommodation chamber 53, the bottom portion of the capsule 50 serves as the inlet portion 54, and thus the second aerosol flow path 57 described above is not formed. That is, the aerosol flow path 90 in the present embodiment includes the first aerosol flow path 46 and the communication hole 33. The cross-sectional area of the first end portion 461 of the first aerosol flow path 46 connected to the heating chamber 43 is smaller than the cross-sectional area of the second end portion 462 of the first aerosol flow path 46 connected to the communication hole 33. The cross-sectional area of the first end portion 461 of the first aerosol flow path 46 connected to the heating chamber 43 is smaller than the cross-sectional area of the communication hole 33. In the present embodiment, in the aerosol flow path 90, the cross-sectional area of the communication hole 33 that constitutes the second end portion connected to the accommodation chamber 53 is also larger than the cross-sectional area of the first end portion 461 of the first aerosol flow path 46 that constitutes the first end portion connected to the heating chamber 43. The aerosol flow path 90 is formed such that the cross-sectional area increases from the first end portion toward the second end portion.

In a state in which the capsule 50 is accommodated in the capsule holder 30, a space may be formed between the bottom wall 32 of the capsule holder 30 and the bottom portion of the capsule 50. That is, the aerosol flow path 90 in the present embodiment includes the first aerosol flow path 46, the communication hole 33, and the space formed between the bottom wall 32 of the capsule holder 30 and the bottom portion of the capsule 50. The cross-sectional area of the first end portion 461 of the first aerosol flow path 46 connected to the heating chamber 43 is smaller than the cross-sectional area of the second end portion 462 of the first aerosol flow path 46 connected to the communication hole 33. The cross-sectional area of the first end portion 461 of the first aerosol flow path 46 connected to the heating chamber 43 is smaller than the cross-sectional area of the communication hole 33. The cross-sectional area of the communication hole 33 is smaller than the cross-sectional area of the space formed between the bottom wall 32 of the capsule holder 30 and the bottom portion of the capsule 50. In this case, in the aerosol flow path 90, the cross-sectional area of the space that is formed between the bottom wall 32 of the capsule holder 30 and the bottom portion of the capsule 50 and that constitutes the second end portion connected to the accommodation chamber 53 is also larger than the cross-sectional area of the first end portion 461 of the first aerosol flow path 46 that constitutes the first end portion connected to the heating chamber 43. The aerosol flow path 90 is formed such that the cross-sectional area increases from the first end portion toward the second end portion.

The capsule 50 is accommodated in the hollow portion of the hollow and substantially annular capsule holder 30 such that the cylindrical axis direction extending in a substantially cylindrical shape is the first direction X, which is the longitudinal direction of the aerosol inhaler 1. Further, the capsule 50 is accommodated in the hollow portion of the capsule holder 30 such that the inlet portion 54 is at the bottom side (that is, a cartridge 40 side) of the aerosol inhaler 1 and the outlet portion 55 is at the top side of the aerosol inhaler 1 in the first direction X. In a state of being accommodated in the hollow portion of the capsule holder 30, the capsule 50 is accommodated in the hollow portion of the capsule holder 30 such that an end portion at the other end side of the side wall 51 is exposed in the first direction X from an end portion at the top side of the capsule holder 30. The end portion at the other end side of the side wall 51 serves as the inhalation port 58 through which the user performs an inhaling operation during use of the aerosol inhaler 1. The end portion at the other end side of the side wall 51 may have a step so as to be easily exposed in the first direction X from the end portion at the top side of the capsule holder 30.

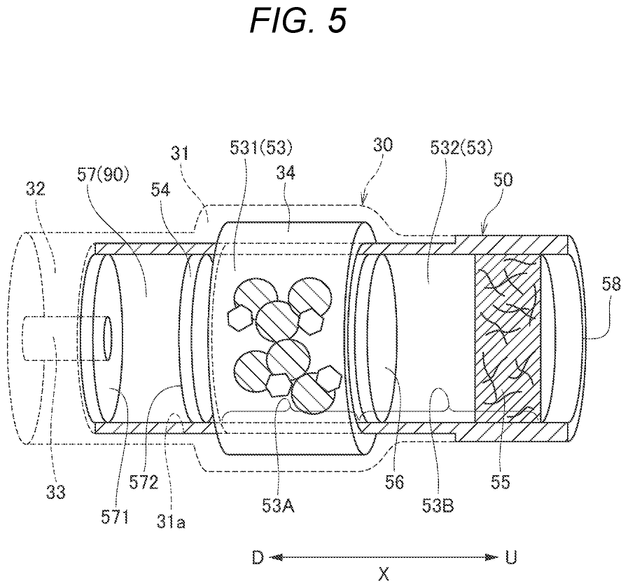

As shown in FIG. 5, in a state in which the capsule 50 is accommodated in the hollow portion of the cartridge cover 20 having a hollow and substantially annular shape, a part of the accommodation chamber 53 is accommodated in a hollow portion of the annular second load 34 provided in the capsule holder 30.

Returning to FIG. 3, in a state of being accommodated in the hollow portion of the cartridge cover 20 in the cylindrical axis direction of the capsule 50, the accommodation chamber 53 includes a heating region 53A in which the second load 34 of the capsule holder 30 is disposed, and a non-heating region 53B which is located between the heating region 53A and the outlet portion 55, which is adjacent to the outlet portion 55, and in which the second load 34 of the capsule holder 30 is not disposed.

In the present embodiment, in the cylindrical axis direction of the capsule 50, the heating region 53A overlaps at least a part of the first space 531, and the non-heating region 53B overlaps at least a part of the second space 532. In the present embodiment, in the cylindrical axis direction of the capsule 50, the first space 531 and the heating region 53A substantially coincide with each other, and the second space 532 and the non-heating region 53B substantially coincide with each other.

(Configuration of Aerosol Inhaler During Use)

The aerosol inhaler 1 implemented in this way is used in a state in which the cartridge cover 20, the capsule holder 30, the cartridge 40, and the capsule 50 are mounted on the power supply unit 10. In this state, the aerosol flow path 90 is formed in the aerosol inhaler 1 by at least the first aerosol flow path 46 provided in the cartridge 40 and the communication hole 33 provided in the bottom wall 32 of the capsule holder 30. When the accommodation chamber 53 is formed in the internal space of the capsule 50 as shown in FIG. 3, the second aerosol flow path 57 provided in the capsule 50 also constitutes a part of the aerosol flow path 90. When the capsule 50 is accommodated in the capsule holder 30 and a space is formed between the bottom wall of the capsule holder 30 and the bottom portion of the capsule 50, the space formed between the bottom wall of the capsule holder 30 and the bottom portion of the capsule 50 also constitutes a part of the aerosol flow path 90. The aerosol flow path 90 connects the heating chamber 43 of the cartridge 40 and the accommodation chamber 53 of the capsule 50, and transports the aerosol 72 generated in the heating chamber 43 from the heating chamber 43 to the accommodation chamber 53.

When the user performs an inhaling operation through the inhalation port 58 during use of the aerosol inhaler 1, air flowing in from the air intake port (not shown) provided in the power supply unit case 11 is taken into the heating chamber 43 of the cartridge 40 from the air supply portion 13 provided on the top surface 11a of the power supply unit case 11, as indicated by the arrow B in FIG. 3. Further, the first load 45 generates heat, the aerosol source 71 held by the wick 44 is heated, and the aerosol source 71 heated by the first load 45 is vaporized and/or atomized in the heating chamber 43. The aerosol source 71 vaporized and/or atomized by the first load 45 aerosolizes the air taken into the heating chamber 43 from the air supply portion 13 of the power supply unit case 11 as a dispersion medium. The aerosol source 71 vaporized and/or atomized in the heating chamber 43 and the air taken into the heating chamber 43 from the air supply portion 13 of the power supply unit case 11 flow through, while being further aerosolized, the first aerosol flow path 46 from the first end portion 461 of the first aerosol flow path 46 communicating with the heating chamber 43 to the second end portion 462 of the first aerosol flow path 46. The aerosol 72 generated in this way is introduced from the second end portion 462 of the first aerosol flow path 46 into the accommodation chamber 53 through the inlet portion 54 of the capsule 50 by passing through the communication hole 33 provided in the bottom wall 32 of the capsule holder 30. According to the embodiment, before being introduced into the accommodation chamber 53, the aerosol 72 flows through the second aerosol flow path 57 provided in the capsule 50 or flows through the space formed between the bottom wall of the capsule holder 30 and the bottom portion of the capsule 50.

When flowing through the accommodation chamber 53 in the first direction X of the aerosol inhaler 1 from the inlet portion 54 to the outlet portion 55, the aerosol 72 introduced into the accommodation chamber 53 through the inlet portion 54 passes through the flavor source 52 accommodated in the first space 531 so as to be added with a flavor component from the flavor source 52.

In this way, the aerosol 72 flows through the accommodation chamber 53 in the first direction X of the aerosol inhaler 1 from the inlet portion 54 to the outlet portion 55. Therefore, in the present embodiment, in the accommodation chamber 53, a flow direction of the aerosol 72 in which the aerosol 72 flows from the inlet portion 54 to the outlet portion 55 is the cylindrical axis direction of the capsule 50, and is the first direction X of the aerosol inhaler 1.

Further, during use of the aerosol inhaler 1, the second load 34 provided in the capsule holder 30 generates heat to heat the heating region 53A of the accommodation chamber 53. Accordingly, the flavor source 52 accommodated in the first space 531 of the accommodation chamber 53 and the aerosol 72 flowing through the heating region 53A of the accommodation chamber 53 are heated.

(Details of Power Supply Unit)

Next, the power supply unit 10 will be described in detail with reference to FIG. 6. As shown in FIG. 6, in the power supply unit 10, the DC/DC converter 66 which is an example of a voltage converter capable of converting an output voltage of the power supply 61 and applying the converted output voltage to the first load 45 is connected between the first load 45 and the power supply 61 in a state in which the cartridge 40 is mounted on the power supply unit 10. The MCU 63 is connected between the DC/DC converter 66 and the power supply 61. The second load 34 is connected to a connection node between the MCU 63 and the DC/DC converter 66 in a state in which the cartridge 40 is mounted on the power supply unit 10. In this way, in the power supply unit 10, the second load 34 and a series circuit of the DC/DC converter 66 and the first load 45 are connected in parallel to the power supply 61 in a state in which the cartridge 40 is mounted.

The DC/DC converter 66 is controlled by the MCU 63 and is a step-up circuit capable of stepping up an input voltage (for example, an output voltage of the power supply 61). The DC/DC converter 66 can apply an input voltage or a voltage obtained by stepping up the input voltage to the first load 45. Since power supplied to the first load 45 can be adjusted by changing a voltage applied to the first load 45 by the DC/DC converter 66, an amount of the aerosol source 71 vaporized or atomized by the first load 45 can be controlled. The DC/DC converter 66 is, for example, a switching regulator that converts an input voltage into a desired output voltage by controlling an on/off time of a switching element while monitoring an output voltage. When a switching regulator is used as the DC/DC converter 66, by controlling the switching element, an input voltage can be directly output without being stepped up. For example, the DC/DC converter 66 may be used to set a voltage applied to the first load 45 to V1 to V5 [V] to be described later.

The MCU 63 can acquire a temperature of the second load 34, a temperature of the flavor source 52, or a temperature of the accommodation chamber 53 (that is, a second temperature T2 to be described later) in order to control discharging to the second load 34. In addition, the MCU 63 can preferably acquire a temperature of the first load 45. The temperature of the first load 45 can be used to prevent overheating of the first load 45 and the aerosol source 71 and highly control an amount of the aerosol source 71 vaporized or atomized by the first load 45.

The voltage sensor 671 measures a value of a voltage applied to the first load 45 and outputs the value of the voltage. The current sensor 672 measures a value of a current that flows through the first load 45 and outputs the current value. An output of the voltage sensor 671 and an output of the current sensor 672 are input to the MCU 63. The MCU 63 acquires a resistance value of the first load 45 based on the output of the voltage sensor 671 and the output of the current sensor 672, and acquires the temperature of the first load 45 based on the acquired resistance value of the first load 45.

In a configuration in which a constant current flows through the first load 45 when the resistance value of the first load 45 is acquired, the current sensor 672 is unnecessary in the first temperature detection element 67. Similarly, in a configuration in which a constant voltage is applied to the first load 45 when the resistance value of the first load 45 is acquired, the voltage sensor 671 is unnecessary in the first temperature detection element 67.

The voltage sensor 681 measures a value of a voltage applied to the second load 34 and outputs the value of the voltage. The current sensor 682 measures a value of a current that flows through the second load 34 and outputs the value of the current. An output of the voltage sensor 681 and an output of the current sensor 682 are input to the MCU 63. The MCU 63 acquires a resistance value of the second load 34 based on the output of the voltage sensor 681 and the output of the current sensor 682, and acquires a temperature of the second load 34 based on the acquired resistance value of the second load 34.

Here, the temperature of the second load 34 does not strictly coincide with the temperature of the flavor source 52 heated by the second load 34, and can be regarded as substantially the same as the temperature of the flavor source 52. In addition, the temperature of the second load 34 does not strictly coincide with the temperature of the accommodation chamber 53 of the capsule 50 heated by the second load 34, and can be regarded as substantially the same as the temperature of the accommodation chamber 53 of the capsule 50. Therefore, the second temperature detection element 68 can also be used as a temperature detection element for detecting the temperature of the flavor source 52 or the temperature of the accommodation chamber 53 of the capsule 50.

In a configuration in which a constant current flows through the second load 34 when the resistance value of the second load 34 is acquired, the current sensor 682 is unnecessary in the second temperature detection element 68. Similarly, in a configuration in which a constant voltage is applied to the second load 34 when the resistance value of the second load 34 is acquired, the voltage sensor 681 is unnecessary in the second temperature detection element 68.

Even when the second temperature detection element 68 is provided in the capsule holder 30 or the cartridge 40, the temperature of the second load 34, the temperature of the flavor source 52, or the temperature of the accommodation chamber 53 of the capsule 50 can be acquired based on an output of the second temperature detection element 68, and the second temperature detection element 68 is preferably provided in the power supply unit 10 with a lowest replacement frequency in the aerosol inhaler 1. In this way, it is possible to reduce the manufacturing cost of the capsule holder 30 and the cartridge 40 and provide, to the user at low cost, the capsule holder 30 and the cartridge 40 whose replacement frequencies are higher than that of the power supply unit 10.

FIG. 7 is a diagram showing a specific example of the power supply unit 10 shown in FIG. 6. FIG. 7 shows a specific example of a configuration in which the current sensor 682 is not provided as the second temperature detection element 68 and the current sensor 672 is not provided as the first temperature detection element 67.

As shown in FIG. 7, the power supply unit 10 includes the power supply 61, the MCU 63, the LDO regulator 65, a parallel circuit C1 including a switch SW1 and a series circuit of a resistance element R1 and a switch SW2 connected in parallel to the switch SW1, a parallel circuit C2 including a switch SW3 and a series circuit of a resistance element R2 and a switch SW4 connected in parallel to the switch SW3, an operational amplifier OP1 and an analog-to-digital converter ADC1 that constitute the voltage sensor 671, and an operational amplifier OP2 and an analog-to-digital converter ADC2 that constitute the voltage sensor 681.

The resistance element described in the present description may be an element having a fixed electric resistance value, for example, a resistor, a diode, or a transistor. In the example of FIG. 7, each of the resistance element R1 and the resistance element R2 is a resistor.

The switch described in the present description is a switching element such as a transistor that switches a wiring path between disconnection and conduction, and for example, the switch may be a bipolar transistor such as an insulated gate bipolar transistor (IGBT) or a field effect transistor such as a metal-oxide-semiconductor field-effect transistor (MOSFET). In addition, the switch described in the present description may be implemented by a relay. In the example of FIG. 7, each of the switches SW1 to SW4 is a transistor.

The LDO regulator 65 is connected to a main positive bus LU connected to a positive electrode of the power supply 61. The MCU 63 is connected to the LDO regulator 65 and a main negative bus LD connected to a negative electrode of the power supply 61. The MCU 63 is also connected to each of the switches SW1 to SW4, and controls opening and closing of the switches SW1 to SW4. The LDO regulator 65 steps down the voltage from the power supply 61 and outputs the stepped-down voltage. An output voltage V0 of the LDO regulator 65 is also used as an operation voltage of each of the MCU 63, the DC/DC converter 66, the operational amplifier OP1, the operational amplifier OP2, and the notification unit 16.

The DC/DC converter 66 is connected to the main positive bus LU. The first load 45 is connected to the main negative bus LD. The parallel circuit C1 is connected to the DC/DC converter 66 and the first load 45.

The parallel circuit C2 is connected to the main positive bus LU. The second load 34 is connected to the parallel circuit C2 and the main negative bus LD.

A non-inverting input terminal of the operational amplifier OP1 is connected to a connection node between the parallel circuit C1 and the first load 45. An inverting input terminal of the operational amplifier OP1 is connected to each of an output terminal of the operational amplifier OP1 and the main negative bus LD via a resistance element.

A non-inverting input terminal of the operational amplifier OP2 is connected to a connection node between the parallel circuit C2 and the second load 34. An inverting input terminal of the operational amplifier OP2 is connected to each of an output terminal of the operational amplifier OP2 and the main negative bus LD via a resistance element.

The analog-to-digital converter ADC1 is connected to the output terminal of the operational amplifier OP1. The analog-to-digital converter ADC2 is connected to the output terminal of the operational amplifier OP2. The analog-to-digital converter ADC1 and the analog-to-digital converter ADC2 may be provided outside the MCU 63.

(MCU)

Next, functions of the MCU 63 will be described. The MCU 63 includes a temperature detection unit, a power control unit, and a notification control unit as functional blocks implemented by a processor executing a program stored in the ROM.

The temperature detection unit acquires a first temperature T1 which is a temperature of the first load 45 based on an output of the first temperature detection element 67. In addition, the temperature detection unit acquires a second temperature T2, which is the temperature of the second load 34, the temperature of the flavor source 52, or the temperature of the accommodation chamber 53, based on an output of the second temperature detection element 68.

In a case of the circuit example shown in FIG. 7, the temperature detection unit controls the switch SW1, the switch SW3, and the switch SW4 to be in a disconnection state, acquires an output value of the analog-to-digital converter ADC1 (the value of the voltage applied to the first load 45) in a state in which the switch SW2 is controlled to be in a conductive state, and acquires the first temperature T1 based on the output value.

The non-inverting input terminal of the operational amplifier OP1 may be connected to a terminal of the resistance element R1 on a DC/DC converter 66 side, and the inverting input terminal of the operational amplifier OP1 may be connected to a terminal of the resistance element R1 on a switch SW2 side. In this case, the temperature detection unit controls the switch SW1, the switch SW3, and the switch SW4 to be in a disconnection state, acquires an output value of the analog-to-digital converter ADC1 (a value of a voltage applied to the resistance element R1) in a state in which the switch SW2 is controlled to be in a conductive state, and acquires the first temperature T1 based on the output value.

In addition, in the case of the circuit example shown in FIG. 7, the temperature detection unit controls the switch SW1, the switch SW2, and the switch SW3 to be in a disconnection state, acquires an output value of the analog-to-digital converter ADC2 (the value of the voltage value applied to the second load 34) in a state in which the switch SW4 is controlled to be in a conductive state, and acquires the second temperature T2 based on the output value.

The non-inverting input terminal of the operational amplifier OP2 may be connected to a terminal of the resistance element R2 on a main positive bus LU side, and the inverting input terminal of the operational amplifier OP2 may be connected to a terminal of the resistance element R2 on a switch SW4 side. In this case, the temperature detection unit controls the switch SW1, the switch SW2, and the switch SW3 to be in a disconnection state, acquires an output value of the analog-to-digital converter ADC2 (a value of a voltage applied to the resistance element R2) in a state in which the switch SW4 is controlled to be in a conductive state, and acquires the second temperature T2 based on the output value.

The notification control unit controls the notification unit 16 to notify the user of various kinds of information. For example, when it is detected to be a replacement timing of the capsule 50, the notification control unit controls the notification unit 16 to perform a capsule replacement notification for prompting replacement of the capsule 50. In addition, when it is detected to be a replacement timing of the cartridge 40, the notification control unit controls the notification unit 16 to perform a cartridge replacement notification for prompting replacement of the cartridge 40. Further, when it is detected that a remaining amount of the power supply 61 is low, the notification control unit may control the notification unit 16 to make a notification for prompting replacement or charging of the power supply 61, or may control the notification unit 16 to make a notification about a control state (for example, a menthol mode or a regular mode to be described later) of the MCU 63 at a predetermined timing.

The power control unit controls discharging from the power supply 61 to the first load 45 (hereinafter, also simply referred to as discharging to the first load 45) and discharging from the power supply 61 to the second load 34 (hereinafter, also simply referred to as discharging to the second load 34). For example, when the power supply unit 10 has the circuit configuration shown in FIG. 7, the power control unit can implement the discharging to the first load 45 by setting the switch SW2, the switch SW3, and the switch SW4 to a disconnection state (that is, OFF) and setting the switch SW1 to a conductive state (that is, ON). In addition, when the power supply unit 10 has the circuit configuration shown in FIG. 7, the power control unit can implement the discharging to the second load 34 by setting the switch SW1, the switch SW2, and the switch SW4 to a disconnection state and setting the switch SW3 to a conductive state.

When an aerosol generation request from the user is detected based on an output of the inhalation sensor 62 (that is, when the user performs an inhaling operation), the power control unit performs the discharging to the first load 45 and the second load 34. Accordingly, the aerosol source 71 is heated by the first load 45 (that is, aerosol is generated) and the flavor source 52 is heated by the second load 34 in response to the aerosol generation request. At this time, the power control unit controls the discharging to the first load 45 and the second load 34 such that an amount of a flavor component added from the flavor source 52 (hereinafter, simply referred to as a flavor component amount, and for example, a flavor component amount W_{flavor} to be described later) to aerosol (vaporized and/or atomized aerosol source 71) generated in response to the aerosol generation request converges to a predetermined target amount. The target amount is a value determined as appropriate, and for example, a target range of the flavor component amount may be determined as appropriate, and a median value in the target range may be determined as the target amount. Accordingly, the flavor component amount converges to the target amount, such that the flavor component amount can converge in the target range having a certain range. A unit of the flavor component amount and the target amount may be weight (for example, [mg]).

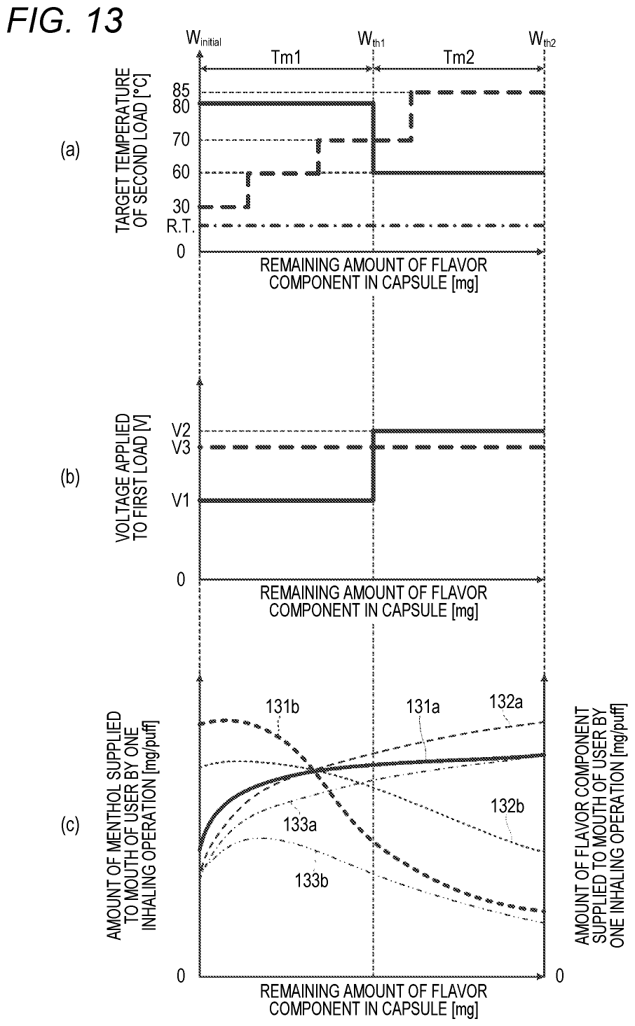

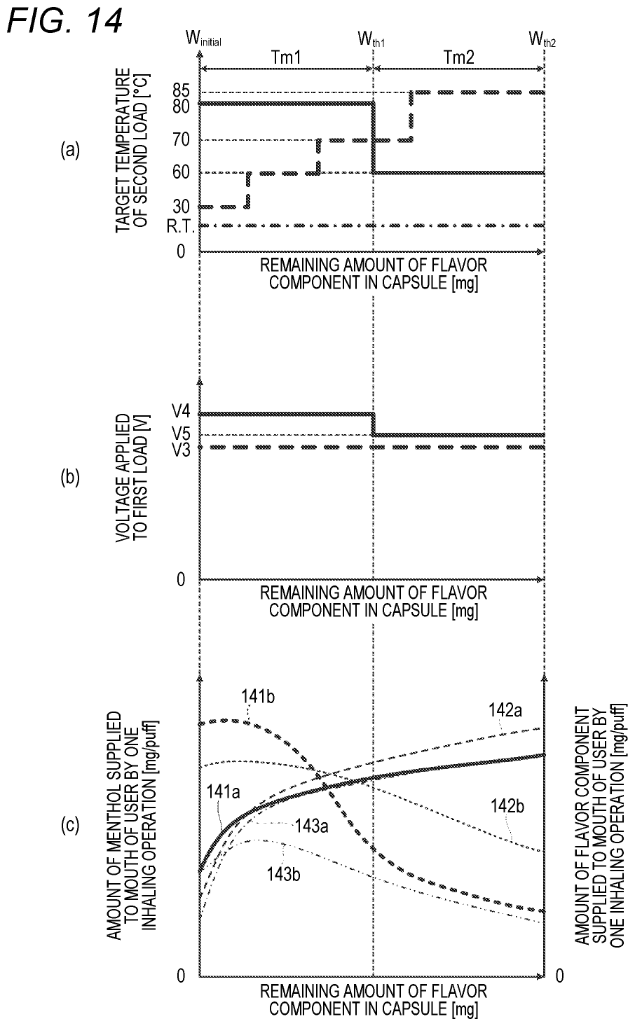

For example, the power control unit sets a manner of the discharging to the first load 45 and a manner of the discharging to the second load 34 to be different from each other when neither the aerosol source 71 nor the flavor source 52 contains menthol, when only the aerosol source 71 in the aerosol source 71 and the flavor source 52 contains menthol, and when both the aerosol source 71 and the flavor source 52 in the aerosol source 71 and the flavor source 52 contain menthol. Accordingly, the discharging to the first load 45 and the second load 34 can be appropriately controlled in response to a flavor type of the aerosol source 71 of the cartridge 40 and the flavor source 52 of the capsule 50, which are mounted on the aerosol inhaler 1, and aerosol containing an appropriate amount of flavor component or an appropriate amount of menthol can be stably supplied to the user. Specific examples of the manner of the discharging to the first load 45 and the manner of the discharging to the second load 34 in each case will be described later with reference to FIGS. 13 and 14.

In addition, in order to appropriately implement the discharging to the first load 45 and the discharging to the second load 34 in accordance with the flavor type of the aerosol source 71 of the cartridge 40 and the flavor source 52 of the capsule 50, which are mounted on the aerosol inhaler 1, the MCU 63 can determine (identify) whether the aerosol source 71 stored in the cartridge 40 and the flavor source 52 accommodated in the capsule 50 contain menthol. The power control unit controls the discharging to the first load 45 and the discharging to the second load 34 based on a determination result (an identification result). The determination on whether the aerosol source 71 and the flavor source 52 contain menthol may be implemented using any method. For example, as will be described later, the MCU 63 may determine whether the aerosol source 71 and the flavor source 52 contain menthol based on an operation performed on the operation unit 15. In addition, for example, as will be described later, the MCU 63 may determine whether the aerosol source 71 and the flavor source 52 contain menthol regardless of the operation performed on the operation unit 15 by the user.

The MCU 63 has a plurality of modes for operating the aerosol inhaler 1 by controlling the discharging from the power supply 61 to the first load 45 and the discharging from the power supply 61 to the second load 34. The MCU 63 has at least a regular mode to be described later, a menthol mode to be described later, an error mode to be described later, and a sleep mode to be described later, as modes for operating the aerosol inhaler 1. Power consumption of the aerosol inhaler 1 in the sleep mode is lower than that in the regular mode and the menthol mode, and the sleep mode can be directly or indirectly transitioned to the regular mode and the menthol mode. Further, the MCU 63 may further have a power mode as a mode for operating the aerosol inhaler 1. Here, the power consumption of the aerosol inhaler 1 in the sleep mode is lower than that in the power mode, and the sleep mode can be transitioned to the power mode. Therefore, the MCU 63 transitions the aerosol inhaler 1 to the sleep mode, such that the power consumption of the aerosol inhaler 1 can be reduced while maintaining a state capable of returning to other modes as needed. In the present embodiment, when the aerosol inhaler 1 is operating in the sleep mode, aerosol generation control is not executed even when the user performs an inhaling operation.

The regular mode is a mode in which the control on the discharging to the first load 45 and the second load 34 is optimized when the flavor type of the aerosol source 71 of the cartridge 40 mounted on the aerosol inhaler 1 is the regular type (that is, when the aerosol source 71 does not contain menthol). The menthol mode is a mode in which the control on the discharging to the first load 45 and the second load 34 is optimized when the flavor type of the aerosol source 71 of the cartridge 40 mounted on the aerosol inhaler 1 is the menthol type (that is, when the aerosol source 71 contains menthol). The error mode is a mode in which the discharging from the power supply 61 to the second load 34 is prevented, and is, for example, a mode in which control is performed such that the discharging from the power supply 61 to the second load 34 is not performed.

The menthol mode may be subdivided into a first menthol mode and a second menthol mode. For example, the first menthol mode is a mode optimized when the flavor types of both the aerosol source 71 of the cartridge 40 and the flavor source 52 of the capsule 50, which are mounted on the aerosol inhaler 1, are the menthol type (that is, when both the aerosol source 71 and the flavor source 52 contain menthol). The second menthol mode is a mode optimized when the flavor type of only the aerosol source 71 of the cartridge 40 in the aerosol source 71 of the cartridge 40 and the flavor source 52 of the capsule 50, which are mounted on the aerosol inhaler 1, is the menthol type (that is, when only the aerosol source 71 in the aerosol source 71 and the flavor source 52 contains menthol).

The MCU 63 sets a target temperature of the second load 34 (hereinafter, referred to as T_{cap_target}) based on whether a current mode is the regular mode or the menthol mode, and a flavor component remaining amount W_{capsule} (n_{puff}−1) contained in the flavor source 52. In the following description, the flavor component remaining amount W_{capsule} may be simply referred to as a remaining amount of the flavor source 52.

The power control unit controls the discharging from the power supply 61 to the first load 45 and the discharging from the power supply 61 to the second load 34 such that the temperature of the second load 34 based on the output of the second temperature detection element 68 (hereinafter, also referred to as temperature T_{cap_sense}) converges to the set target temperature T_{cap_target}.

Accordingly, the discharging to the first load 45 and the second load 34 can be appropriately controlled in response to the flavor types of the aerosol source 71 of the cartridge 40 and the flavor source 52 of the capsule 50, which are mounted on the aerosol inhaler 1, and aerosol containing an appropriate amount of flavor component or an appropriate amount of menthol can be stably supplied to the user.

Specific examples of the control on the discharging to the first load 45 and the second load 34 in each case will be described later with reference to FIGS. 13 and 14.

(Various Parameters Used for Generating Aerosol)

Before specific control on the discharging to the first load 45 and the like performed by the MCU 63 is described, various parameters used for the control on the discharging to the first load 45 and the like performed by the MCU 63 will be described.

A weight [mg] of aerosol that is generated by being heated with the first load 45 and that passes through the flavor source 52 (that is, inside the capsule 50) in response to one inhaling operation performed by the user is defined as an aerosol weight Wₐₑᵣₒₛₒₗ. Power required to be supplied to the first load 45 in order to generate aerosol having the aerosol weight Wₐₑᵣₒₛₒₗ is defined as atomized power P_{liquid}. A supply time of the atomized power P_{liquid} to the first load 45 is defined as a supply time tₛₑₙₛₑ. From the viewpoint of preventing overheating of the first load 45 and the like, a predetermined upper limit value tᵤₚₚₑᵣ (for example, 2.4 [s]) is set for the supply time tₛₑₙₛₑ, and the MCU 63 stops power supply to the first load 45 regardless of an output value of the inhalation sensor 62 when the supply time tₛₑₙₛₑ reaches the upper limit value tᵤₚₚₑᵣ (see steps S38 and S39 to be described later).

A weight [mg] of a flavor component contained in the flavor source 52 when the user performs an inhaling operation for n_{puff} times (n_{puff} is a natural number of 0 or more) after the capsule 50 is mounted on the aerosol inhaler 1 is defined as a flavor component remaining amount W_{capsule} (n_{puff}). A weight [mg] of a flavor component contained in the flavor source 52 of the new capsule 50 (capsule 50 in which the inhaling operation is not performed even once after being mounted), that is, the flavor component remaining amount W_{capsule} (n_{puff}=0) is also defined as Wᵢₙᵢₜᵢₐₗ.

A weight [mg] of a flavor component added to the aerosol passing through the flavor source 52 (that is, inside the capsule 50) in response to one inhaling operation performed by the user is defined as a flavor component amount W_{flavor}. A parameter related to a temperature of the flavor source 52 is defined as a temperature parameter T_{capsule}. The temperature parameter T_{capsule} is a parameter indicating the second temperature T2 described above, and is, for example, a parameter indicating a temperature of the second load 34.

It is experimentally found that the flavor component amount W_{flavor} depends on the flavor component remaining amount W_{capsule}, the temperature parameter T_{capsule}, and the aerosol weight Wₐₑᵣₒₛₒₗ. Therefore, the flavor component amount W_{flavor} can be modeled by the following formula (1).

W_{flavor}=β×(W_{capsule}×T_{capsule})×γ×Wₐₑᵣₒₛₒₗ (1)

β in the above formula (1) is a coefficient indicating a ratio of a flavor component to be added to the aerosol generated in response to one inhaling operation performed by the user when the aerosol passes through the flavor source 52, and is obtained from experiments. γ in the above formula (1) is a coefficient obtained from experiments. In a period in which one inhaling operation is performed, the temperature parameter T_{capsule} and the flavor component remaining amount W_{capsule} may vary, and γ is introduced here in order to treat the temperature parameter T_{capsule} and the flavor component remaining amount W_{capsule} as constant values.

The flavor component remaining amount W_{capsule} is decreased each time the user performs an inhaling operation. Therefore, the flavor component remaining amount W_{capsule} is inversely proportional to the number of times of the inhaling operation (hereinafter, also referred to as the number of times of inhalation). In the aerosol inhaler 1, since the discharging to the first load 45 is performed each time an inhaling operation is performed, it can be said that the flavor component remaining amount W_{capsule} is inversely proportional to the number of times the discharging to the first load 45 is performed to generate aerosol or a cumulative value in a period in which the discharging to the first load 45 is performed.

As can be seen from the above formula (1), when it is assumed that the aerosol weight Wₐₑᵣₒₛₒₗ generated in response to one inhaling operation performed by the user is controlled to be substantially constant, it is necessary to increase the temperature parameter T_{capsule} (that is, the temperature of the flavor source 52) as the flavor component remaining amount W_{capsule} decreases (that is, the number of times of inhalation increases) in order to stabilize the flavor component amount W_{flavor}.

Therefore, when the flavor type of the aerosol source 71 of the cartridge 40 in the aerosol source 71 of the cartridge 40 and the flavor source 52 of the capsule 50, which are mounted on the aerosol inhaler 1, is the regular type (that is, when the aerosol source 71 does not contain menthol), the MCU 63 (the power control unit) operates in the regular mode to control the discharging to the first load 45 and the second load 34. When operating in the regular mode, the MCU 63 controls the discharging to the second load 34 in order to increase the temperature of the flavor source 52 as the flavor component remaining amount W_{capsule} decreases (that is, the number of times of inhalation increases) (see FIGS. 13 and 14).

On the other hand, the MCU 63 (the power control unit) operates in the menthol mode different from the regular mode when the flavor type of the aerosol source 71 of the cartridge 40 in the aerosol source 71 of the cartridge 40 and the flavor source 52 of the capsule 50, which are mounted on the aerosol inhaler 1, is the menthol type (that is, when the aerosol source 71 contains menthol). When operating in the menthol mode, the MCU 63 controls the discharging to the second load 34 in order to lower the temperature of the flavor source 52 as the flavor component remaining amount W_{capsule} decreases (that is, the number of times of inhalation increases) from the viewpoint of supplying an appropriate amount of menthol to the user (see FIGS. 13 and 14). Accordingly, as will be described later, it is possible to supply an appropriate amount of menthol to the user.

When the temperature of the flavor source 52 is lowered as the flavor component remaining amount W_{capsule} decreases, the flavor component amount W_{flavor} decreases. Therefore, when the temperature of the flavor source 52 is lowered as the flavor component remaining amount W_{capsule} decreases, the MCU 63 may increase the aerosol weight Wₐₑᵣₒₛₒₗ by increasing a voltage applied to the first load 45 to increase power supplied to the first load 45 (see FIG. 13). Accordingly, a decrease in the flavor component amount W_{flavor} caused by lowering the temperature of the flavor source 52 in order to supply an appropriate amount of menthol to the user can be compensated by an increase in the aerosol weight Wₐₑᵣₒₛₒₗ of aerosol generated by being heated with the first load 45. Therefore, it is possible to prevent a decrease in the flavor component amount W_{flavor} supplied to a mouth of the user, and it is possible to stably supply menthol and a flavor component to the user.

(Operation of Aerosol Inhaler)

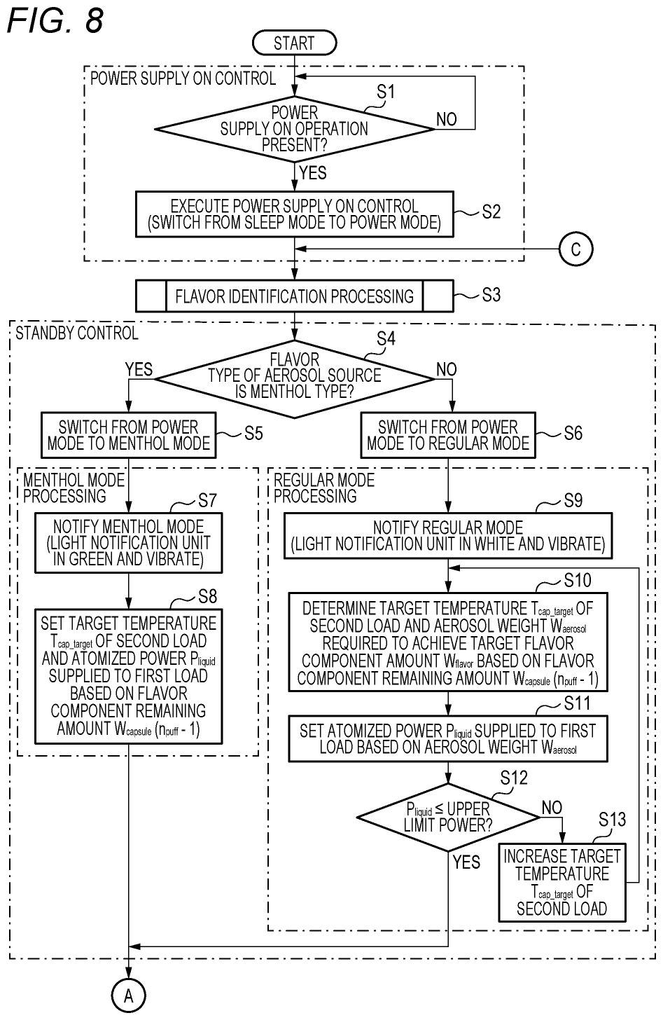

Next, an example of an operation of the aerosol inhaler 1 will be described with reference to FIGS. 8 to 12. For example, the operation of the aerosol inhaler 1 to be described below is implemented by a processor of the MCU 63 executing a program stored in advance in the memory 63a or the like.

<Power Supply ON Control>

As shown in FIG. 8, when a power supply ON operation is performed on the operation unit 15 by the user (step S1: YES), the MCU 63 executes power supply ON control to switch the mode for operating the aerosol inhaler 1 from the sleep mode to the power mode (step S2). On the other hand, the MCU 63 waits for the mode for operating the aerosol inhaler 1 to remain in the sleep mode until the power supply ON operation is performed on the operation unit 15 by the user (step S1: NO loop). That is, when it is determined to be YES in step S1, the MCU 63 switches the mode for operating the aerosol inhaler 1 from the sleep mode to the power mode. The power supply ON operation is, for example, an operation in which the operation unit 15 is continuously pressed three times within a predetermined time (for example, 2 [s]).

The MCU 63 may perform preheating control for performing the discharging from the power supply 61 to the second load 34 such that the temperature of the second load 34 becomes a preheating temperature set in advance (hereinafter, also referred to as a preheating temperature T_{cap_pre}) in response to switching from the sleep mode to the power mode. Accordingly, it is possible to increase the temperature of the second load 34 immediately after switching to the power mode. For example, when the MCU 63 executes the aerosol generation control in the menthol mode, the target temperature T_{cap_target} is initially set to 80 [° C.], which is high. Therefore, although a certain period of time is required to reach the target temperature T_{cap_target}, the second load 34 can be brought close to the target temperature T_{cap_target} in advance before the aerosol generation request is detected by performing the preheating control. Accordingly, even when the set target temperature T_{cap_target} is high, the aerosol to which a flavor is appropriately added can be stably supplied to the user immediately after the aerosol generation control is executed (for example, after a so-called inhalation start).

When the mode for operating the aerosol inhaler 1 transitions from the sleep mode to the power mode, the MCU 63 executes flavor identification processing for identifying the flavor types of the aerosol source 71 of the cartridge 40 and the flavor source 52 of the capsule 50 (step S3). Details of the flavor identification processing will be described later.

<Standby Control>

Next, the MCU 63 determines whether the flavor type of the aerosol source 71 of the cartridge 40 is the menthol type based on an identification result of the flavor identification processing (step S4). When the identification result for the flavor type of the aerosol source 71 of the cartridge 40 in the flavor identification processing is set to the menthol type, the MCU 63 makes an affirmative determination in step S4 (step S4: YES), and the processing proceeds to step S5. Subsequently, the MCU 63 switches the mode for operating the aerosol inhaler 1 from the power mode to the menthol mode (step S5), and executes menthol mode processing. On the other hand, when the identification result for the flavor type of the aerosol source 71 of the cartridge 40 in the flavor identification processing is not set to the menthol type, that is, when the identification result for the flavor type of the aerosol source 71 of the cartridge 40 in the flavor identification processing is set to the regular type, the MCU 63 makes a negative determination in step S4 (step S4: NO), and the processing proceeds to step S6. Subsequently, the MCU 63 switches the mode for operating the aerosol inhaler 1 from the power mode to the regular mode (step S6), and executes regular mode processing.

<<Menthol Mode Processing>>

In the menthol mode processing, the MCU 63 first notifies the user of the menthol mode by the notification unit 16 (step S7). At this time, for example, the MCU 63 causes the light emitting element 161 to emit green light and causes the vibration element 162 to vibrate, thereby notifying the user of the menthol mode.

Next, the MCU 63 sets the target temperature T_{cap_target} of the second load 34 and the atomized power to be supplied to the first load 45 (hereinafter, also referred to as atomized power P_{liquid}) based on the flavor component remaining amount W_{capsule} (n_{puff}−1) contained in the flavor source 52 (step S8), and proceeds to step S21. Here, when the inhaling operation is not performed even once after the new capsule 50 is mounted, the flavor component remaining amount W_{capsule} (n_{puff}−1) is Wᵢₙᵢₜᵢₐₗ, and when the inhaling operation is performed once or more, the flavor component remaining amount W_{capsule} (n_{puff}−1) is the flavor component remaining amount W_{capsule} (n_{puff}) calculated by remaining amount update processing (to be described later) immediately before the inhaling operation. A specific setting example of the target temperature T_{cap_target} and the like in the menthol mode will be described later with reference to FIGS. 13 and 14.

<<Regular Mode Processing>>

In the regular mode processing, the MCU 63 first notifies the user of the regular mode by the notification unit 16 (step S9). At this time, for example, the MCU 63 causes the light emitting element 161 to emit white light and causes the vibration element 162 to vibrate, thereby notifying the user of the regular mode.

Next, the MCU 63 determines the target temperature T_{cap_target} of the second load 34 and the aerosol weight Wₐₑᵣₒₛₒₗ required to achieve the target flavor component amount W_{flavor} based on the flavor component remaining amount W_{capsule} (n_{puff}−1) contained in the flavor source 52 (step S10). In step S10, for example, the MCU 63 calculates the aerosol weight Wₐₑᵣₒₛₒₗ according to the following formula (2) obtained by modifying the above formula (1), and determines the calculated aerosol weight Wₐₑᵣₒₛₒₗ as the aerosol weight Wₐₑᵣₒₛₒₗ.

$${W}_{a e r o s o l} = \frac{{W}_{flavor}}{β \cdot {W}_{capsule} ( {n}_{puff} - 1 ) \cdot {T}_{capsule} \cdot γ} \qquad ( 2 )$$

β and γ in the above formula (2) are the same as β and γ in the above formula (1), and are obtained from experiments. In the above formula (2), the target flavor component amount W_{flavor} is set in advance by a manufacturer of the aerosol inhaler 1. When the inhaling operation is not performed even once after the new capsule 50 is mounted, the flavor component remaining amount W_{capsule} (n_{puff}−1) in the above formula (2) is Wᵢₙᵢₜᵢₐₗ, and when the inhaling operation is performed once or more, the flavor component remaining amount W_{capsule} (n_{puff}−1) in the above formula (2) is the flavor component remaining amount W_{capsule} (n_{puff}) calculated in remaining amount update processing immediately before the inhaling operation.

Next, the MCU 63 sets the atomized power P_{liquid} to be supplied to the first load 45 based on the aerosol weight Wₐₑᵣₒₛₒₗ determined in step S10 (step S11). In step S11, the MCU 63 calculates, for example, the atomized power P_{liquid} according to the following formula (3), and sets the calculated atomized power P_{liquid}.

$${P}_{l i q u i d} = \frac{{W}_{aerosol}}{α \cdot t} \qquad ( 3 )$$

α in the above formula (3) is a coefficient obtained from experiments in a similar manner to β and γ. The aerosol weight Wₐₑᵣₒₛₒₗ in the above formula (3) is the aerosol weight Wₐₑᵣₒₛₒₗ determined in step S10. t in the above formula (3) is the supply time tₛₑₙₛₑ in which the atomized power P_{liquid} is expected to be supplied, and may have, for example, the upper limit value tᵤₚₚₑᵣ.

Next, the MCU 63 determines whether the atomized power P_{liquid} determined in step S11 is equal to or smaller than predetermined upper limit power that can be discharged from the power supply 61 to the first load 45 at that time (step S12). When the atomized power P_{liquid} is equal to or smaller than the upper limit power (step S12: Yes), the MCU 63 returns to step S21 described above. On the other hand, when the atomized power P_{liquid} exceeds the upper limit power (step S12: NO), the MCU 63 increases the target temperature T_{cap_target} by a predetermined amount (step S13), and returns to step S10.

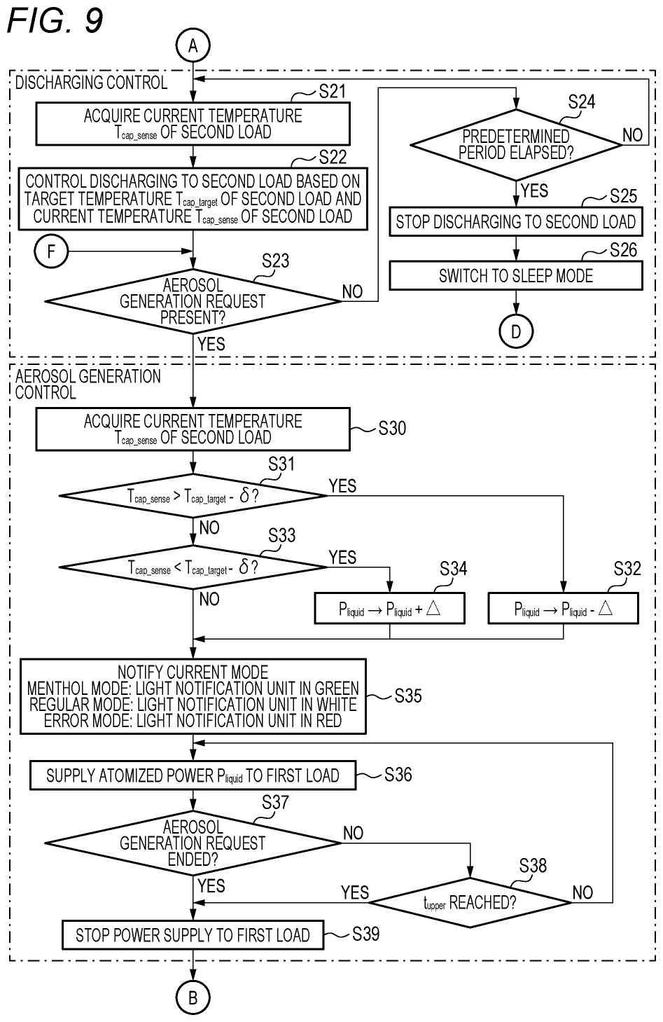

That is, as can be seen from the above formula (1), by increasing the target temperature T_{cap_target} (that is, T_{capsule}), the aerosol weight Wₐₑᵣₒₛₒₗ required to achieve the target flavor component amount W_{flavor} can be reduced by the increase amount of the target temperature T_{cap_target}, and as a result, the atomized power P_{liquid} determined in the above step S11 can be reduced. The MCU 63 repeats steps S10 to S13, so that the determination in step S12 determined initially as NO is determined as YES, and the processing can be shifted to step S21 as shown in FIG. 9.

<Discharging Control>

As shown in FIG. 9, next, the MCU 63 acquires a current temperature of the second load 34 (hereinafter, also referred to as temperature T_{cap_sense}) based on an output of the second temperature detection element 68 (step S21). The temperature T_{cap_sense} which is a temperature of the second load 34 is an example of the temperature parameter T_{capsule} described above. Here, although an example in which the temperature of the second load 34 is used as the temperature parameter T_{capsule} is described, a temperature of the flavor source 52 or the accommodation chamber 53 may be used instead of the temperature of the second load 34.

Next, the MCU 63 controls the discharging from the power supply 61 to the second load 34 based on the target temperature T_{cap_target} set in the menthol mode processing or the regular mode processing and the acquired temperature T_{cap_sense} such that the temperature T_{cap_sense} converges to the target temperature T_{cap_target} (step S22). At this time, the MCU 63 performs, for example, proportional-integral-differential (PID) control such that the temperature T_{cap_sense} converges to the target temperature T_{cap_target}.

As the control for converging the temperature T_{cap_sense} to the target temperature T_{cap_target}, ON and OFF control for turning on and off the power supply to the second load 34, proportional (P) control, proportional-integral (PI) control, or the like may be used instead of the PID control. In addition, the target temperature T_{cap_target} may have hysteresis.

Next, the MCU 63 determines whether there is an aerosol generation request (step S23). When there is no aerosol generation request (step S23: NO), the MCU 63 determines whether a predetermined period is elapsed in a state in which there is no aerosol generation request (step S24). When the predetermined period is not elapsed in a state in which there is no aerosol generation request (step S24: NO), the MCU 63 returns the processing to step S21.

When the predetermined period is elapsed in a state in which there is no aerosol generation request (step S24: YES), the MCU 63 stops the discharging to the second load 34 (step S25), switches the mode for operating the aerosol inhaler 1 to the sleep mode (step S26), and proceeds to step S51 to be described later.

<Aerosol Generation Control>

On the other hand, when there is an aerosol generation request (step S23: YES), the MCU 63 executes aerosol generation control. First, the MCU 63 temporarily stops the heating of the flavor source 52 performed by the second load 34 (that is, the discharging to the second load 34), and acquires the temperature T_{cap_sense} based on an output of the second temperature detection element 68 (step S30). The MCU 63 may not stop the heating of the flavor source 52 performed by the second load 34 (that is, discharging to the second load 34) when executing step S11.

Next, the MCU 63 determines whether the acquired temperature T_{cap_sense} is higher than the set target temperature T_{cap_target}−δ (δ>0) (step S31). δ can be freely determined by a manufacturer of the aerosol inhaler 1. When the temperature T_{cap_sense} is higher than the target temperature T_{cap_target}−δ (step S31: YES), the MCU 63 sets the current atomized power P_{liquid}−Δ (Δ>0) as a new atomized power P_{liquid} (step S32), and proceeds to step S35.

On the other hand, when the temperature T_{cap_sense} is not higher than the target temperature T_{cap_target}−δ (step S31: NO), the MCU 63 determines whether the temperature T_{cap_sense} is lower than the target temperature T_{cap_target}−δ (step S33). When the temperature T_{cap_sense} is lower than the target temperature T_{cap_target}−δ (step S33: YES), the MCU 63 sets the current atomized power P_{liquid}+A as a new atomized power P_{liquid} (step S34), and proceeds to step S35.

On the other hand, when the temperature T_{cap_sense} is not lower than the target temperature T_{cap_target}−δ (step S33: NO), since the temperature T_{cap_sense}=the target temperature T_{cap_target}−δ, the MCU 63 maintains the current atomized power P_{liquid} and proceeds to step S35.

In the present embodiment, when the target temperature T_{cap_target} is controlled by the menthol mode, the MCU 63 changes the target temperature T_{cap_target} from 80 [° C.] to 60 [° C.] in a predetermined period, details of which will be described later with reference to FIG. 14 and the like. Immediately after the target temperature T_{cap_target} is changed in such a manner, the temperature T_{cap_sense} (for example, 80 [° C.]) which is the temperature of the second load 34 at that time may exceed the target temperature T_{cap_target} (that is, 60 [° C.]) after the change. In such a case, the MCU 63 determines as NO in step S32 and performs processing in step S34 to reduce the atomized power P_{liquid}. Accordingly, even when an actual temperature of the flavor source 52, the second load 34, or the like is higher than 60 [° C.] immediately after the target temperature T_{cap_target} is changed from 80 [° C.] to 60 [° C.], the atomized power P_{liquid} can be reduced, and an amount of the aerosol source 71 that is generated by being heated with the first load 45 and is supplied to the flavor source 52 can be reduced. Therefore, it is possible to prevent a large amount of menthol from being supplied to the mouth of the user, and it is possible to stably supply an appropriate amount of menthol to the user.

Next, the MCU 63 notifies the user of the current mode (step S35). For example, in the case of the menthol mode (that is, in a case where menthol mode processing is executed), in step S35, the MCU 63 notifies the user of the menthol mode by, for example, causing the light emitting element 161 to emit green light. On the other hand, in the case of the regular mode (that is, in a case where regular mode processing is executed), in step S35, the MCU 63 notifies the user of the regular mode by, for example, causing the light emitting element 161 to emit white light.

Next, the MCU 63 controls the DC/DC converter 66 such that the atomized power P_{liquid} set in step S33 or step S34 is supplied to the first load 45 (step S36). Specifically, the MCU 63 controls a voltage applied to the first load 45 by the DC/DC converter 66, such that the atomized power P_{liquid} is supplied to the first load 45. Accordingly, the atomized power P_{liquid} is supplied to the first load 45, the aerosol source 71 is heated by the first load 45, and the vaporized and/or atomized aerosol source 71 is generated.

Next, the MCU 63 determines whether the aerosol generation request is ended (step S37). When the aerosol generation request is not ended (step S37: NO), the MCU 63 determines whether an elapsed time from the start of the supply of the atomized power P_{liquid}, that is, the supply time tₛₑₙₛₑ, reaches the upper limit value tᵤₚₚₑᵣ (step S38). When the supply time tₛₑₙₛₑ does not reach the upper limit value tᵤₚₚₑᵣ (step S38: NO), the MCU 63 returns to step S36. In this case, the supply of the atomized power P_{liquid} to the first load 45, that is, the generation of the vaporized and/or atomized aerosol source 71, is continued.

On the other hand, when the aerosol generation request is ended (step S37: YES), and when the supply time tₛₑₙₛₑ reaches the upper limit value tᵤₚₚₑᵣ (step S38: YES), the MCU 63 stops the supply of the atomized power P_{liquid} to the first load 45 (that is, the discharging to the first load 45) (step S39), and ends the aerosol generation control.

In this way, when executing the aerosol generation control, the MCU 63 controls the discharging from the power supply 61 to the first load 45 and the discharging from the power supply 61 to the second load 34 in the menthol mode or the regular mode.

<Remaining Amount Update Processing>

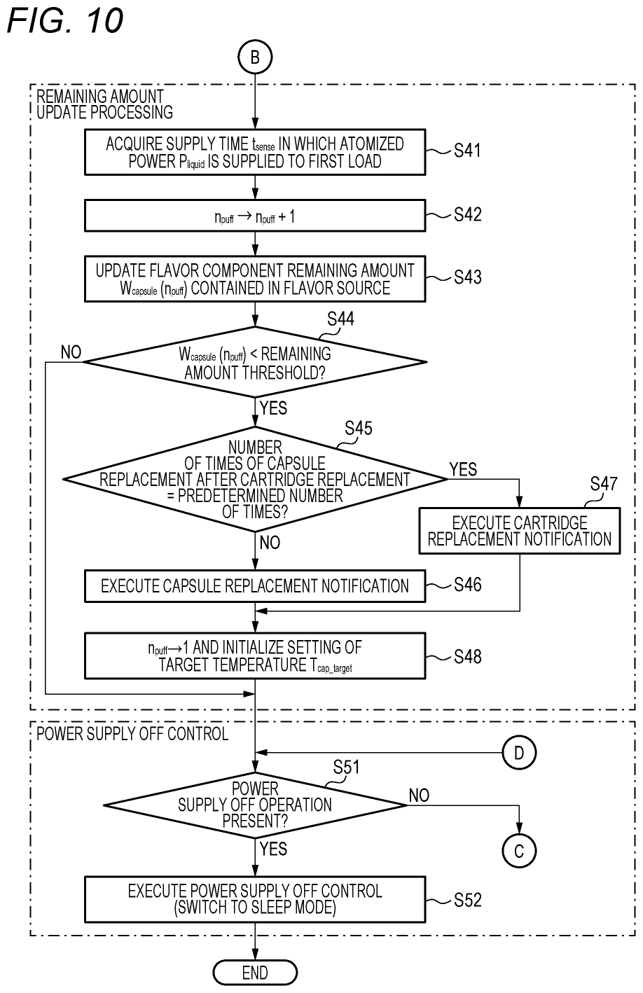

As shown in FIG. 10, when the aerosol generation control is ended, the MCU 63 executes remaining amount update processing for calculating the remaining amount of the flavor component contained in the flavor source 52.

In the remaining amount update processing, the MCU 63 first acquires the supply time tₛₑₙₛₑ in which the atomized power P_{liquid} is supplied (step S41). Next, the MCU 63 adds “1” to n_{puff} which is a count value of a puff number counter (step S42).

Further, the MCU 63 updates the flavor component remaining amount W_{capsule} (n_{puff}) contained in the flavor source 52 based on the acquired supply time tₛₑₙₛₑ, the atomized power P_{liquid} supplied to the first load 45 in response to the aerosol generation request, and the target temperature T_{cap_target} set when the aerosol generation request is detected (step S43). For example, the MCU 63 calculates the flavor component remaining amount W_{capsule} (n_{puff}) according to the following formula (4), and stores the calculated flavor component remaining amount W_{capsule} (n_{puff}) in the memory 63a, thereby updating the flavor component remaining amount W_{capsule} (n_{puff}).

$${W}_{capsule} ( {n}_{puff} ) = {W}_{initial} - δ \cdot {\sum }_{i = 1}^{{n}_{puff} - 1} {W}_{flavor} ( i ) = {W}_{initial} - δ \cdot {\sum }_{i = 1}^{{n}_{puff} - 1} β \cdot {W}_{capsule} ( i ) \cdot {T}_{capsule} ( i ) \cdot γ \cdot α \cdot {P}_{liquid} ( i ) \cdot {t}_{sense} ( i ) \qquad ( 4 )$$

α in the above formula (4) is the same as α in the above formula (3), and is obtained from experiments. β and γ in the above formula (4) are the same as β and γ in the above formula (1), and are obtained from experiments. In addition, δ in the above formula (4) is the same as δ used in step S32, and is set in advance by a manufacturer of the aerosol inhaler 1.

Next, the MCU 63 determines whether the updated flavor component remaining amount W_{capsule} (n_{puff}) is less than a predetermined remaining amount threshold that is a condition for performing a capsule replacement notification (step S44). When the updated flavor component remaining amount W_{capsule} (n_{puff}) is equal to or larger than the remaining amount threshold (step S44: NO), it is considered that the flavor component contained in the flavor source 52 (that is, in the capsule 50) is still sufficient, and thus the MCU 63 proceeds to step S51.

On the other hand, when the updated flavor component remaining amount W_{capsule} (n_{puff}) is less than the remaining amount threshold (step S44: YES), it is considered that the flavor component contained in the flavor source 52 almost runs out, and thus the MCU 63 determines whether replacement of the capsule 50 is performed for a predetermined number of times after replacement of the cartridge 40 (step S45). For example, in the present embodiment, the aerosol inhaler 1 is provided to the user in a manner of combining five capsules 50 with one cartridge 40. In this case, in step S25, the MCU 63 determines whether the replacement of the capsule 50 is performed for five times after the replacement of the cartridge 40.

When the replacement of the capsule 50 is not performed for a predetermined number of times (five time in the present embodiment) after the replacement of the cartridge 40 (step S45: NO), it is estimated that the remaining amount of the aerosol source 71 of the cartridge 40 is equal to or greater than an amount required to make the remaining amount of the flavor source 52 that is not used equal to or less than the threshold, and the MCU 63 performs the capsule replacement notification assuming that the cartridge 40 is still in a usable state (step S46). In the present embodiment, the MCU 63 performs the capsule replacement notification by blinking the light emitting element 161 in green when the aerosol inhaler 1 is operated in the menthol mode and in white when the aerosol inhaler 1 is operated in the regular mode.

On the other hand, when the replacement of the cartridge 50 is performed for a predetermined number of times (five times in the present embodiment) after the replacement of the cartridge 40 (step S45: NO), it is estimated that the remaining amount of the aerosol source 71 of the cartridge 40 is less than the amount required to make the remaining amount of the flavor source 52 that is not used equal to or less than the threshold, and the MCU 63 performs the capsule replacement notification assuming that the cartridge 40 reaches the end of its life (step S47). In the present embodiment, the MCU 63 performs the cartridge replacement notification by the light emitting element 161 blinking in blue.

Next, the MCU 63 executes counter reset control for resetting the count value of the puff number counter to 1 and initializes the setting of the target temperature T_{cap_target} (step S48). In initialization on the setting of the target temperature T_{cap_target}, for example, the MCU 63 sets the target temperature T_{cap_target} to −273 [° C.] which is absolute zero. Accordingly, regardless of the temperature of the second load 34 at that time, the discharging to the second load 34 can be substantially stopped, and the heating of the flavor source 52 performed by the second load 34 can be substantially stopped.

<Power Supply OFF Control>

Next, the MCU 63 determines whether a power supply OFF operation is performed on the operation unit 15 by the user (step S51). In the present embodiment, the power supply OFF operation is an operation of maintaining a state in which the operation unit 15 is pressed for a predetermined time (for example, 3 [s]) or longer. Further, when the power supply OFF operation is not performed on the operation unit 15 by the user (step S51: NO), the MCU 63 returns to step S3. On the other hand, when the power supply OFF operation is performed on the operation unit 15 by the user (step S51: YES), the MCU 63 executes power supply OFF control to switch the mode for operating the aerosol inhaler 1 to the sleep mode (step S52), and ends the series of processing.

<Flavor Identification Processing>

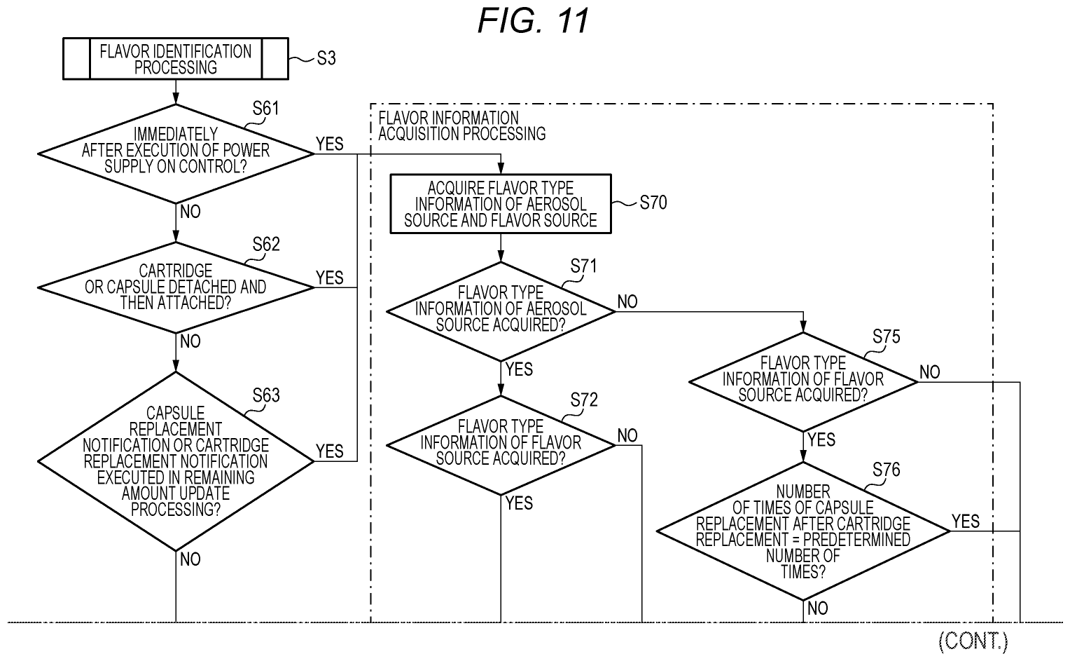

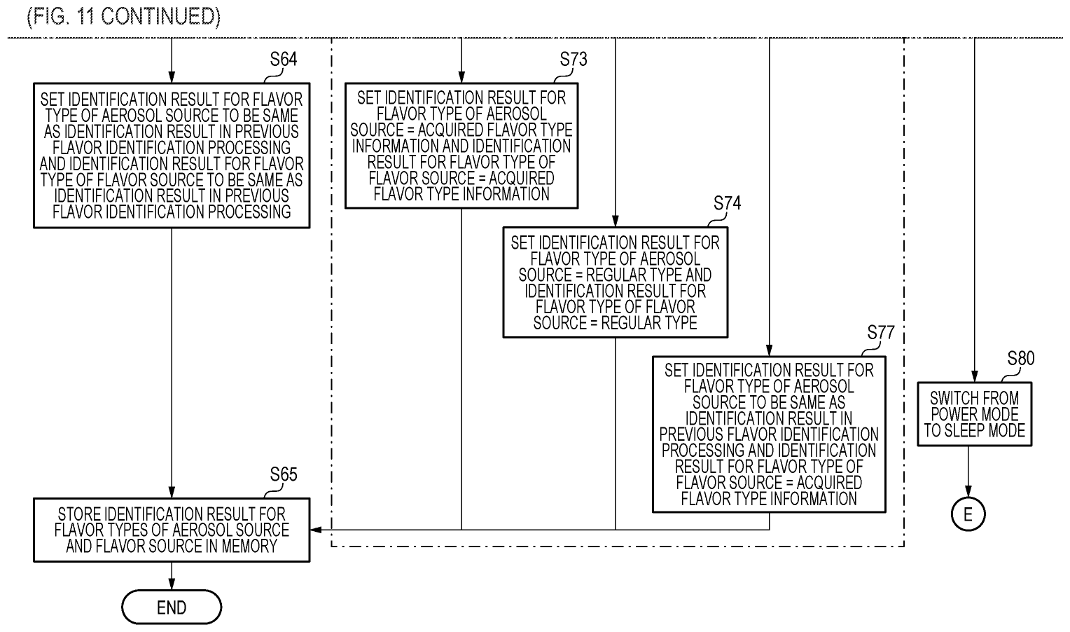

Next, the flavor identification processing shown in step S3 will be described in detail with reference to FIG. 11.

As shown in FIG. 11, in the flavor identification processing, the MCU 63 first determines whether it is immediately after the power supply ON control is executed (step S61). For example, when the flavor identification processing is not executed even once after the power supply ON control is executed, the MCU 63 determines that it is immediately after the power supply ON control is executed (step S61: YES), proceeds to step S70, and executes flavor information acquisition processing to be described later. On the other hand, when the flavor identification processing is executed once or more after the power supply ON control is executed, the MCU 63 determines that it is not immediately after the power supply ON control is executed (step S61: NO), and determines whether the cartridge 40 or the capsule 50 is attached or detached (step S62).

The MCU 63 may detect the attachment and detachment of the cartridge 40 and the capsule 50 using any method in step S62.

For example, the MCU 63 may detect the attachment and detachment of the cartridge 40 based on an electric resistance value between a pair of discharge terminals 12 acquired using the voltage sensor 671 and the current sensor 672 or an electric resistance value between a pair of discharge terminals 17 acquired using the voltage sensor 681 and the current sensor 682. It is clear that the electric resistance value between the discharge terminals 12 that can be acquired by the MCU 63 is different between a state in which the pair of discharge terminals 12 are electrically connected by connecting the first load 45 between the pair of discharge terminals 12 and a state in which the first load 45 is not connected between the pair of discharge terminals 12 and the pair of discharge terminals 12 are insulated by air. Therefore, the MCU 63 can detect the attachment and detachment of the cartridge 40 based on the electric resistance value between the discharge terminals 12.

Similarly, it is clear that the electric resistance value between the discharge terminals 17 that can be acquired by the MCU 63 is different between a state in which the pair of discharge terminals 17 are electrically connected by connecting the second load 34 between the pair of discharge terminals 17 and a state in which the second load 34 is not connected between the pair of discharge terminals 17 and the pair of discharge terminals 17 are insulated by air. Therefore, the MCU 63 can detect the attachment and detachment of the cartridge 40 based on the electric resistance value between the discharge terminals 17.

In addition, the MCU 63 may detect attachment and detachment of the capsule 50 based on fluctuation in the electric resistance value between the pair of discharge terminals 12 acquired using the voltage sensor 671 and the current sensor 672 or fluctuation in the electric resistance value between the pair of discharge terminals 17 acquired using the voltage sensor 681 and the current sensor 682. For example, when the capsule 50 is attached and detached, stress is applied to the discharge terminals 12 and the discharge terminals 17 due to the attachment and detachment. This stress causes fluctuation in the electric resistance value between the pair of discharge terminals 12 and the electric resistance value between the pair of discharge terminals 17. Therefore, the MCU 63 can detect the attachment and detachment of the capsule 50 based on the fluctuation in the electric resistance value between the discharge terminals 12 and the fluctuation in the electric resistance value between the discharge terminals 17.

In addition, the MCU 63 may detect attachment and detachment of the cartridge 40 and the capsule 50 based on information stored in the storage medium provided in each of the cartridge 40 and the capsule 50. For example, when the information stored in the storage medium transitions from an acquirable (readable) state to an unacquirable state, the MCU 63 detects detachment of the cartridge 40 and the capsule 50. In addition, when the information stored in the storage medium transitions from an unacquirable state to an acquirable state, the MCU 63 detects the attachment of the cartridge 40 and the capsule 50.

In addition, identification information (ID) for identifying the cartridge 40 and the capsule 50 may be stored in the storage medium provided in each of the cartridge 40 and the capsule 50, and the MCU 63 may detect attachment and detachment of the cartridge 40 and the capsule 50 based on the identification information. In this case, when the identification information on the cartridge 40 and the capsule 50 changes, the MCU 63 detects attachment and detachment (in this case, replacement) of the cartridge 40 and the capsule 50.

The MCU 63 may detect the attachment and detachment of the cartridge 40 and the capsule 50 based on light transmittance and light reflectance of the cartridge 40 and the capsule 50. For example, when the light transmittance and the light reflectance of the cartridge 40 and the capsule 50 change from a value indicating attachment to a value indicating detachment, the MCU 63 detects detachment of the cartridge 40 and the capsule 50. In addition, when the light transmittance and the light reflectance of the cartridge 40 and the capsule 50 change from a value indicating detachment to a value indicating attachment, the MCU 63 detects attachment of the cartridge 40 and the capsule 50.

When at least one of the cartridge 40 and the capsule 50 is attached or detached (step S62: YES), the flavor type of at least one of the aerosol source 71 of the cartridge 40 and the flavor source 52 of the capsule 50 may be changed, and thus the MCU 63 proceeds to step S70 described above and executes the flavor information acquisition processing to be described later.

When the cartridge 40 and the capsule 50 are not attached or detached (step S62: NO), it is determined whether the capsule replacement notification (step S46) or the cartridge replacement notification (step S47) is executed in the remaining amount update processing (step S63). Step S62 may be omitted. That is, when a negative determination is made in step S61 (step S61: NO), the MCU 63 may advance the processing to step S63. By omitting step S62, the function of detecting the attachment and detachment of the cartridge 40 and the capsule 50 described above becomes unnecessary, and thus the cost and the volume of the power supply unit 10 can be reduced.

When the capsule replacement notification (step S46) or the cartridge replacement notification (step S47) is executed in the remaining amount update processing (step S63: YES), it is in a state in which the flavor component contained in the flavor source 52 of the capsule 50 almost disappears or the cartridge 40 reaches the end of its life. Therefore, even though at least one of the cartridge 40 and the capsule 50 is attached or detached, the detection of the attachment or detachment of the cartridge 40 and the capsule 50 in step S62 may be erroneous detection. Therefore, the MCU 63 proceeds to step S70 described above, and executes flavor information acquisition processing to be described later.

When the capsule replacement notification (step S46) or the cartridge replacement notification (step S47) is not executed in the remaining amount update processing (step S63: NO), it is considered that the attachment and detachment of the cartridge 40 and the capsule 50 are not performed since the previous execution of the flavor identification processing, and the flavor types of the aerosol source 71 of the cartridge 40 and the flavor source 52 of the capsule 50 are not changed from the identification result in the previous flavor identification processing. Therefore, the MCU 63 reads, from the memory 63a, the identification result for the flavor type of the aerosol source 71 and the identification result for the flavor type of the flavor source 52 in the previous flavor identification processing. The MCU 63 sets the identification result for the flavor type of the aerosol source 71 to be the same as the identification result for the flavor type of the aerosol source 71 in the previous flavor identification processing, and sets the identification result for the flavor type of the flavor source 52 to be the same as the identification result for the flavor type of the flavor source 52 in the previous flavor identification processing (step S64). Then, the identification results for the flavor types of the aerosol source 71 and the flavor source 52 in the flavor identification processing are stored in the memory 63a (step S65), and the flavor identification processing is ended.

<<Flavor Information Acquisition Processing>>

In step S70, the flavor type information of the aerosol source 71 of the cartridge 40 and the flavor source 52 of the capsule 50 is acquired.

The flavor information acquisition processing may include first flavor information acquisition processing of acquiring the flavor type information of the aerosol source 71 of the cartridge 40 and the flavor source 52 of the capsule 50 based on the operation performed on the operation unit 15 by the user, and second flavor information acquisition processing of acquiring the flavor type information of the aerosol source 71 of the cartridge 40 and the flavor source 52 of the capsule 50 without the operation performed on the operation unit 15 by the user. In this case, the second flavor information acquisition processing is executed when the first flavor information acquisition processing cannot be executed.

In the first flavor information acquisition processing, for example, when the operation unit 15 is continuously pressed three times by the user within a predetermined time (for example, 2 [s]), flavor type information indicating that both the flavor types of the aerosol source 71 of the cartridge 40 and the flavor source 52 of the capsule 50 are regular types may be acquired. In addition, in the first flavor information acquisition processing, for example, when the operation unit 15 is continuously pressed five times by the user within a predetermined time (for example, 2 [s]), flavor type information indicating that both the flavor types of the aerosol source 71 of the cartridge 40 and the flavor source 52 of the capsule 50 are menthol types may be acquired.

In the second flavor information acquisition processing, for example, the MCU 63 is provided with a storage medium (for example, an IC chip) that stores information indicating a flavor type in the cartridge 40 or the capsule 50, and the MCU 63 can acquire the flavor type information of the aerosol source 71 of the cartridge 40 and the flavor source 52 of the capsule 50 by reading the information stored in the storage medium. In addition, the electrical resistance value of the first load 45 provided in the cartridge 40 may be made different according to the flavor type, and the MCU 63 may acquire the flavor type information of the aerosol source 71 of the cartridge 40 based on the electrical resistance value. In addition, instead of the electrical resistance value, other detectable physical quantities such as light transmittance and reflectance in the capsule 50 and the cartridge 40 may be used to acquire the flavor type information of the aerosol source 71 of the cartridge 40 and the flavor source 52 of the capsule 50.

In step S70, by executing the second flavor information acquisition processing when the first flavor information acquisition processing cannot be executed, the MCU 63 mainly acquires the flavor type information of the aerosol source 71 and the flavor source 52 by the second flavor information acquisition processing only when the user does not perform an operation of designating the flavor types of the aerosol source 71 and the flavor source 52. Accordingly, the MCU 63 can operate in a mode corresponding to the flavor types of the aerosol source 71 and the flavor source 52 while taking the intention of the user into account.

When the operation unit 15 is operated by the user after the execution of the second flavor information acquisition processing, the first flavor information acquisition processing is executed, and the flavor type information of the aerosol source 71 and the flavor source 52 is acquired based on an execution result of the first flavor information acquisition processing.

Accordingly, since the flavor type information based on the operation performed on the operation unit 15 by the user can be preferentially applied to the flavor type information of the aerosol source 71 of the cartridge 40 and the flavor source 52 of the capsule 50, it is possible to provide the power supply unit 10 for the aerosol inhaler 1 with high marketability in which the intention of the user is further taken into account.

Next, the MCU 63 determines whether the flavor type information of the aerosol source 71 of the cartridge 40 can be acquired in step S70 executed immediately before (step S71).

When the flavor type information of the aerosol source 71 of the cartridge 40 can be acquired in step S70 executed immediately before (step S71: YES), the MCU 63 determines whether the flavor type information of the flavor source 52 of the capsule 50 can be acquired in step S70 executed immediately before (step S72).

When the flavor type information of the flavor source 52 of the capsule 50 can be acquired in step S70 which is executed immediately before this processing (step S72: YES), the identification result for the flavor type of the aerosol source 71 is set to the acquired flavor type information, and the identification result for the flavor type of the flavor source 52 is set to the acquired flavor type information (step S73). Then, the processing proceeds to step S65, the identification results for the flavor types of the aerosol source 71 and the flavor source 52 in the flavor identification processing are stored in the memory 63a, and the flavor identification processing is ended.

When the flavor type information of the flavor source 52 of the capsule 50 cannot be acquired in the step S70 executed immediately before (step S72: NO), regardless of the flavor type information of the aerosol source 71 of the cartridge 40 acquired in the step S70, the identification result for the flavor type of the aerosol source 71 is set to the regular type, and the identification result for the flavor type of the flavor source 52 is set to the regular type (step S74). Then, the processing proceeds to step S65, the identification results for the flavor types of the aerosol source 71 and the flavor source 52 in the flavor identification processing are stored in the memory 63a, and the flavor identification processing is ended.

On the other hand, when the flavor type information of the aerosol source 71 of the cartridge 40 cannot be acquired in step S70 executed immediately before (step S71: NO), the MCU 63 determines whether the flavor type information of the flavor source 52 of the capsule 50 can be acquired in step S70 executed immediately before (step S75).

When the flavor type information of the flavor source 52 of the capsule 50 cannot be acquired in step S70 executed immediately before (step S75: NO), both the flavor type information of the aerosol source 71 of the cartridge 40 and the flavor type information of the flavor source 52 of the capsule 50 are unknown. In such a case, the MCU 63 switches the mode for operating the aerosol inhaler 1 from the power mode to the error mode (step S80), and executes error mode processing. Details of the error mode processing will be described later.

When the flavor type information of the flavor source 52 of the capsule 50 can be acquired in step S70 executed immediately before (step S75: YES), the MCU 63 determines whether the number of times of replacement of the capsule 50 after replacement of the cartridge 40 is a predetermined number of times (five times in the present embodiment) (step S76).

When the number of times of replacement of the capsule 50 after replacement of the cartridge 40 is not the predetermined number of times (five times in the present embodiment) (step S76: NO), it is estimated that the remaining amount of the aerosol source 71 of the cartridge 40 is equal to or larger than the amount necessary to make the remaining amount of the flavor source 52 that is not used equal to or less than the threshold. When the remaining amount of the aerosol source 71 of the cartridge 40 is equal to or greater than the amount required to make the remaining amount of the flavor source 52 that is not used equal to or less than the threshold, the cartridge 40 can be used until the flavor component contained in the flavor source 52 of the capsule 50 that is not used is almost eliminated with the remaining amount of the aerosol source 71 of the cartridge 40, and thus it is considered that the cartridge 40 is not replaced after the previous execution of the flavor identification processing. Therefore, the MCU 63 reads, from the memory 63a, the identification result for the flavor type of the aerosol source 71 in the previous flavor identification processing, sets the identification result for the flavor type of the aerosol source 71 to be the same as the identification result for the flavor type of the aerosol source 71 in the previous flavor identification processing, and sets the identification result for the flavor type of the flavor source 52 to the acquired flavor type information (step S77). Then, the processing proceeds to step S65, the identification results of the flavor types of the aerosol source 71 and the flavor source 52 in the flavor identification processing are stored in the memory 63a, and the flavor identification processing is ended.

When the number of times of replacement of the capsule 50 after replacement of the cartridge 40 is a predetermined number of times (five times in the present embodiment) (step S76: YES), it is estimated that the remaining amount of the aerosol source 71 of the cartridge 40 is less than the amount required to make the remaining amount of the flavor source 52 that is not used equal to or less than the threshold. When the remaining amount of the aerosol source 71 of the cartridge 40 is less than the amount required to make the remaining amount of the flavor source 52 that is not used equal to or less than the threshold, the cartridge 40 cannot be used until the flavor component contained in the flavor source 52 of the capsule 50 that is not used almost disappears with the remaining amount of the aerosol source 71 of the cartridge 40, and thus it is considered that the cartridge 40 is replaced after the previous execution of the flavor identification processing. In this case, since the flavor type information of the aerosol source 71 of the cartridge 40 is unknown and cannot be estimated, the processing proceeds to step S80, the mode for operating the aerosol inhaler 1 is switched from the power mode to the error mode, and the error mode processing is executed.

<<Error Mode Processing>>

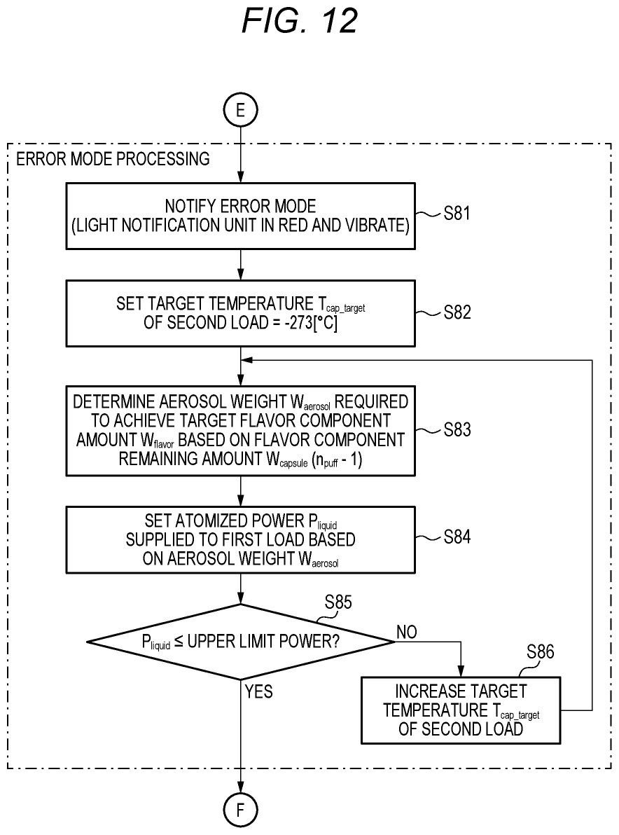

As shown in FIG. 12, in the error mode processing, the MCU 63 first notifies the user of the error mode by the notification unit 16 (step S81). At this time, the MCU 63 notifies the regular mode, for example, by causing the light emitting element 161 to emit red light and causing the vibration element 162 to vibrate.

Next, the MCU 63 sets the target temperature T_{cap_target} of the second load 34 to −273 [° C.] which is absolute zero (step S82). Accordingly, regardless of the temperature of the second load 34 at that time, the discharging to the second load 34 can be substantially stopped, and the heating of the flavor source 52 performed by the second load 34 can be substantially stopped. The MCU 63 may perform control so as to prevent the discharging from the power supply 61 to the second load 34 in the error mode, and in step S82, the target temperature T_{cap_target} of the second load 34 may be set to a temperature other than −273 [° C.] which is absolute zero, for example, a room temperature.

Next, the MCU 63 determines the aerosol weight Wₐₑᵣₒₛₒₗ required to achieve the target flavor component amount W_{flavor} based on the flavor component remaining amount W_{capsule} (n_{puff}−1) contained in the flavor source 52 (step S83). Next, the MCU 63 sets the atomized power P_{liquid} to be supplied to the first load 45 based on the aerosol weight Wₐₑᵣₒₛₒₗ determined in step S83 (step S84).

Next, the MCU 63 determines whether the atomized power P_{liquid} determined in step S84 is equal to or smaller than predetermined upper limit power that can be discharged from the power supply 61 to the first load 45 at that time (step S85). When the atomized power P_{liquid} is equal to or smaller than the upper limit power (step S85: Yes), the MCU 63 transitions to step S23 described above. On the other hand, when the atomized power P_{liquid} exceeds the upper limit power (step S85: NO), the MCU 63 increases the target temperature T_{cap_target} by a predetermined amount (step S86), and returns to step S83.

The control on the discharging from the power supply 61 to the first load 45 in the error mode is the same control as the control on the discharging from the power supply 61 to the first load 45 in the regular mode described above. Specifically, the atomized power P_{liquid} set based on the aerosol weight Wₐₑᵣₒₛₒₗ in step S83 of the error mode processing has the same value as the atomized power P_{liquid} set based on the aerosol weight Wₐₑᵣₒₛₒₗ in step S10 of the regular mode. That is, when the aerosol weight Wₐₑᵣₒₛₒₗ is equal, the atomization power P_{liquid} set in step S83 of the error mode processing and the atomized power P_{liquid} set in step S10 of the regular mode have the same value.

In this way, the MCU 63 executes the flavor information acquisition processing in response to the detection of the attachment and detachment of at least one of the cartridge 40 and the capsule 50 (step S62: YES) in the flavor identification processing. That is, it is possible to execute the flavor information acquisition processing in a state in which there is a possibility that the flavor type of at least one of the aerosol source 71 of the cartridge 40 and the flavor source 52 of the capsule 50 is changed. Accordingly, it is possible to save the power consumption of the power supply 61 that is consumed by the flavor information acquisition processing.

In addition, in the remaining amount update processing, when at least one of the remaining amount of the aerosol source 71 and the remaining amount of the flavor source 52 is less than the threshold, the MCU 63 executes the flavor information acquisition processing after the capsule replacement notification or the cartridge replacement notification is executed and before the aerosol generation control is executed. When there is a possibility that the flavor type of at least one of the aerosol source 71 of the cartridge 40 and the flavor source 52 of the capsule 50 is changed, that is, before the first inhaling after the capsule replacement notification or the cartridge replacement notification is performed, the flavor information acquisition processing can be executed. Accordingly, it is possible to save the power of the power supply 61 consumed by the flavor information acquisition processing. At the same time, the power supply unit 10 of the aerosol inhaler 1 does not necessarily detect the replacement of the capsule 50 that accommodates the flavor source 52 and the cartridge 40 that stores the aerosol source 71, and thus the cost and volume of the power supply unit 10 for the aerosol inhaler 1 can be reduced.

In addition, when the flavor type information of the aerosol source 71 of the cartridge 40 can be acquired in step S70 (step S71: YES) and the flavor type information of the flavor source 52 of the capsule 50 cannot be acquired in step S70 (step S72: NO), in the flavor identification processing, the MCU 63 sets the identification result for the flavor type of the aerosol source 71 to the regular type and sets the identification result for the flavor type of the flavor source 52 to the regular type regardless of the flavor type information of the aerosol source 71 of the cartridge 40 acquired in step S70 (step S74). Therefore, the MCU 63 makes a negative determination in step S4 (step S4: NO), switches the mode for operating the aerosol inhaler 1 from the power mode to the regular mode (step S6), and operates in the regular mode.

Accordingly, when the flavor source 52 does not contain menthol, the MCU 63 is prevented from controlling the second load 34 in the menthol mode, and thus it is possible to prevent the generation of an unintended flavor due to the flavor source 52 not containing menthol being heated in the menthol mode, and it is possible to stably supply at least the flavor derived from the flavor source 52 to the user.

In addition, when the number of times of replacement of the capsule 50 after replacement of the cartridge 40 is not the predetermined number of times (five times in the present embodiment) (step S76: NO), the MCU 63 sets the identification result for the flavor type of the aerosol source 71 to be the same as the identification result for the flavor type of the aerosol source 71 in the previous flavor identification processing, and sets the identification result for the flavor type of the flavor source 52 to the acquired flavor type information (step S77). Accordingly, even when the flavor type information of the aerosol source 71 of the cartridge 40 cannot be acquired in the flavor type information acquisition processing, the identification result for the flavor type of the aerosol source 71 can be set to a highly probable flavor type of the aerosol source 71 in the flavor identification processing, and the probability that the MCU 63 operates in a mode suitable for the flavor type of the aerosol source 71 can be improved.

In addition, when the MCU 63 operates in the error mode, the discharging from the power supply 61 to the second load 34 is prevented, and the discharging from the power supply 61 to the first load 45 is controlled in the same manner as the control on the discharging from the power supply 61 to the first load 45 in the regular mode. Therefore, in the flavor information acquisition processing, when the information on whether both the aerosol source 71 and the flavor source 52 contain the menthol cannot be acquired, and when the information on whether the aerosol source 71 contains the menthol cannot be acquired, the number of times of replacement of the capsule 50 after replacement of the cartridge 40 is a predetermined number of times (five times in the present embodiment), and the flavor type information of the aerosol source 71 cannot be estimated, heating of the flavor source 52 is prevented, and the aerosol source 71 is heated by the same control as in the regular mode. Accordingly, it is possible to prevent the generation of an unintended flavor due to the heating of the flavor source 52, and it is possible to stably supply at least the flavor derived from the flavor source 52 to the user.

Instead of the embodiment described above, when the MCU 63 operates in the error mode, the discharging to the first load 45 may also be prevented. In this case, steps S82 to S86 of the error mode processing may be omitted, and the MCU 63 may advance the processing to step S51 after the execution of step S81.

(Specific Control Example when Cartridge 40 and Capsule 50 are of Menthol Type)

Next, a specific control example of the MCU 63 when both the cartridge 40 and the capsule 50 are of the menthol type will be described with reference to FIG. 13. Here, it is assumed that an inhaling operation is performed for a predetermined number of times from when the new capsule 50 is mounted on the aerosol inhaler 1 up to when the flavor component remaining amount in the capsule 50 is smaller than the above-described remaining amount threshold (that is, when the flavor component remaining amount in the capsule 50 almost runs out). In addition, it is assumed that a sufficient amount of the aerosol source 71 is stored in the cartridge 40 during a period in which the inhaling operation is performed for a predetermined number of times.

In parts (a), (b), and (c) of FIG. 13, a horizontal axis indicates a remaining amount [mg] of the flavor component contained in the flavor source 52 in the capsule 50 (that is, the flavor component remaining amount W_{capsule}) A vertical axis in part (a) of FIG. 13 indicates a target temperature (that is, the target temperature T_{cap_target}) [° C.] of the second load 34 which is a heater for heating the capsule 50 (that is, the flavor source 52). A vertical axis in part (b) of FIG. 13 indicates a voltage [V] applied to the first load 45 which is a heater for heating the aerosol source 71 stored in the cartridge 40.

A vertical axis at a left side in part (c) of FIG. 13 indicates an amount of menthol supplied to the mouth of the user by one inhaling operation [mg/puff]. A vertical axis at a right side in part (c) of FIG. 13 indicates an amount of the flavor component supplied to the mouth of the user by one inhaling operation [mg/puff]. Hereinafter, the amount of menthol supplied to the mouth of the user by one inhaling operation is also referred to as a unit supply menthol amount. Hereinafter, the amount of the flavor component supplied to the mouth of the user by one inhaling operation is also referred to as a unit supply flavor component amount.

In FIG. 13, a first period Tm1 is a certain period immediately after the capsule 50 is replaced. Specifically, the first period Tm1 is a period from when the flavor component remaining amount in the capsule 50 is Wᵢₙᵢₜᵢₐₗ up to when the flavor component remaining amount in the capsule 50 reaches Wₜₕ₁ which is set in advance by a manufacturer of the aerosol inhaler 1. Here, Wₜₕ₁ is set to a value smaller than Wᵢₙᵢₜᵢₐₗ and larger than Wₜₕ₂ that is the above-described remaining amount threshold which is a condition for performing the capsule replacement notification. For example, Wₜₕ₁ may be a flavor component remaining amount when the inhaling operation is performed for about ten times after the new capsule 50 is mounted. In FIG. 13, a second period Tm2 is a period after the first period Tm1, and specifically, is a period from when the flavor component remaining amount in the capsule 50 reaches Wₜₕ₁ up to when the flavor component remaining amount reaches Wₜₕ₂.

When both the cartridge 40 and the capsule 50 are of the menthol type, as described above, the MCU 63 controls the discharging to the first load 45 and the discharging to the second load 34 by the menthol mode. Specifically, in the menthol mode in this case, the MCU 63 sets the target temperature of the second load 34 in the first period Tm1 to 80 [° C.], as indicated by a thick solid line in part (a) of FIG. 13.

The target temperature (80 [° C.]) of the second load 34 in the first period Tm1 in this case is an example of a first target temperature in the present invention. For example, the target temperature of the second load 34 in the first period Tm1 (that is, the first target temperature) in this case is a temperature higher than a melting point (for example, 42 [° C.] to 45 [° C.]) of the menthol and lower than a boiling point (for example, 212 [° C.] to 216 [° C.]) of the menthol. In addition, the target temperature of the second load 34 in the first period Tm1 (that is, the first target temperature) in this case may be a temperature equal to or lower than 90 [° C.]. Accordingly, in the present embodiment, the temperature of the second load 34 (that is, the flavor source 52) in the first period Tm1 is controlled to converge to 80 [° C.] which is an example of the first target temperature. Therefore, in the first period Tm1, since the menthol adsorbed to the flavor source 52 is heated to an appropriate temperature by the second load 34, rapid progress of desorption of the menthol from the flavor source 52 can be prevented, and an appropriate amount of menthol can be stably supplied to the user.

Further, in the menthol mode in a case where both the cartridge 40 and the capsule 50 are of the menthol type, in the second period Tm2 after the first period Tm1, the MCU 63 sets the target temperature of the second load 34 to 60 [° C.] which is lower than the target temperature in the immediately preceding first period Tm1. The target temperature (60 [° C.]) of the second load 34 in the second period Tm2 in this case is an example of a second target temperature in the present invention. For example, the target temperature of the second load 34 in the second period Tm2 (that is, the second target temperature) in this case is also a temperature higher than the melting point of the menthol and lower than the boiling point of the menthol. In addition, the target temperature of the second load 34 in the second period Tm2 (that is, the second target temperature) in this case may be a temperature equal to or lower than 90 [° C.]. Accordingly, in the present embodiment, the temperature of the second load 34 (that is, the flavor source 52) in the second period Tm2 is controlled to converge to 60 [° C.] which is an example of the second target temperature. Therefore, in the second period Tm2, since the menthol adsorbed to the flavor source 52 is also heated to an appropriate temperature by the second load 34, rapid progress of desorption of the menthol from the flavor source 52 can be prevented, and an appropriate amount of menthol can be stably supplied to the user.

In this way, in the menthol mode in which both the cartridge 40 and the capsule 50 are of the menthol type, the temperature of the second load 34 (that is, the flavor source 52) in the second period Tm2 is controlled to converge to a temperature lower than the temperature in the immediately preceding first period Tm1. Specifically, in the present embodiment, the temperature of the second load 34 (that is, the flavor source 52) in the second period Tm2 is controlled to converge to 60 [° C.] which is lower than 80 [° C.] in the immediately preceding first period Tm1.

In the menthol mode in a case where both the cartridge 40 and the capsule 50 are of the menthol type, the MCU 63 sets a voltage applied to the first load 45 in the first period Tm1 to V1 [V] as indicated by a thick solid line in part (b) of FIG. 13. V1 [V] is an example of a first voltage in the present invention, and is a voltage set in advance by a manufacturer of the aerosol inhaler 1. Accordingly, in the first period Tm1 in this case, power corresponding to the applied voltage V1 [V] is supplied from the power supply 61 to the first load 45, and the aerosol source 71 vaporized and/or atomized by an amount corresponding to the power is generated by the first load 45.

Further, in the menthol mode in a case where both the cartridge 40 and the capsule 50 are of the menthol type, the MCU 63 sets a voltage applied to the first load 45 to V2 [V] in the second period Tm2 after the first period Tm1. V2 [V] is an example of a second voltage in the present invention, and is a voltage higher than V1 [V] as shown in part (b) of FIG. 13. V2 [V] is set in advance by a manufacturer of the aerosol inhaler 1. For example, the MCU 63 can apply a voltage such as V1 [V] or V2 [V] to the first load 45 by controlling the DC/DC converter 66.

In this way, in the menthol mode in which both the cartridge 40 and the capsule 50 are of the menthol type, the voltage (here, V2 [V]) applied to the first load 45 in the second period Tm2 is higher than the voltage (here, V1 [V]) applied to the first load 45 in the first period Tm1.

Therefore, in the menthol mode in which both the cartridge 40 and the capsule 50 are of the menthol type, in the second period Tm2, power supplied to the first load 45 is increased as compared with that in the immediately preceding first period Tm1. Accordingly, an amount of the vaporized and/or atomized aerosol source 71 generated by the first load 45 is increased as compared with that in the immediately preceding first period Tm1.

An example of a unit supply menthol amount in a case where both the cartridge 40 and the capsule 50 are of the menthol type and the MCU 63 controls the target temperature of the second load 34 and the voltage applied to the first load 45 by the menthol mode is indicated by a unit supply menthol amount 131a in part (c) of FIG. 13.

An example of a unit supply flavor component amount in a case where both the cartridge 40 and the capsule 50 are of the menthol type and the MCU 63 controls the target temperature of the second load 34 and the voltage applied to the first load 45 by the menthol mode is indicated by a unit supply flavor component amount 131b in part (c) of FIG. 13.

In order to compare the unit supply menthol amount 131a with the unit supply flavor component amount 131b, an example will be described in which the MCU 63 controls the discharging to the first load 45 and the second load 34 (that is, the target temperature of the second load 34 and the voltage applied to the first load 45) by the regular mode even though both the cartridge 40 and the capsule 50 are of the menthol type.

In the regular mode, for example, the MCU 63 increases the target temperature of the second load 34 in the first period Tm1 and the second period Tm2 in a stepwise manner such as 30 [° C.], 60 [° C.], 70 [° C.], and 85 [° C.], as indicated by a thick broken line in part (a) of FIG. 13. The target temperature and a timing of changing the target temperature are set in advance by a manufacturer of the aerosol inhaler 1. As another example, the timing of changing the target temperature of the second load 34 in the regular mode may be determined based on a remaining amount [mg] of the flavor component (that is, the flavor component remaining amount W_{capsule}) contained in the flavor source 52 in the capsule 50.

Here, a maximum value (here, 70 [° C.]) of the target temperature of the second load 34 in the first period Tm1 in the regular mode is lower than the target temperature (here, 80 [° C.]) of the second load 34 in the first period Tm1 in the menthol mode. A minimum value (here, 70 [° C.]) of the target temperature of the second load 34 in the second period Tm2 in the regular mode is higher than the target temperature (here, 60 [° C.]) of the second load 34 in the second period Tm2 in the menthol mode.

In the regular mode, the MCU 63 maintains the voltage applied to the first load 45 in the first period Tm1 and the second period Tm2 at a constant V3 [V], as indicated by a thick broken line in part (b) of FIG. 13. V3 [V] is a voltage higher than V1 [V] and lower than V2 [V], and is a voltage set in advance by a manufacturer of the aerosol inhaler 1. For example, the MCU 63 can apply a voltage of V3 [V] to the first load 45 by controlling the DC/DC converter 66.

An example of a unit supply menthol amount in a case where both the cartridge 40 and the capsule 50 are of the menthol type and the MCU 63 controls the target temperature of the second load 34 and the voltage applied to the first load 45 by the regular mode is indicated by a unit supply menthol amount 132a in part (c) of FIG. 13.

An example of a unit supply flavor component amount in a case where both the cartridge 40 and the capsule 50 are of the menthol type and the MCU 63 controls the target temperature of the second load 34 and the voltage applied to the first load 45 by the regular mode is indicated by a unit supply flavor component amount 132b in part (c) of FIG. 13.

That is, even when both the cartridge 40 and the capsule 50 are of the menthol type, the discharging to the first load 45 and the second load 34 (that is, the target temperature of the second load 34 and the voltage applied to the first load 45) are controlled by the regular mode. In this case, since the target temperature of the second load 34 in the first period Tm1 is lower than that in a case where the target temperature of the second load 34 and the voltage applied to the first load 45 are controlled by the menthol mode, the temperature of the flavor source 52 in the first period Tm1 is low.

Therefore, when the discharging to the first load 45 or the like is controlled by the regular mode in a case where both the cartridge 40 and the capsule 50 are of the menthol type, a time up to when the flavor source 52 (specifically, the cigarette granules 521) and the menthol reach the adsorption equilibrium state in the capsule 50 is longer than that in a case where the discharging to the first load 45 or the like is controlled by the menthol mode. During this period, most menthol derived from the aerosol source 71 is adsorbed to the flavor source 52, and menthol that can pass through the flavor source 52 is reduced.

As described above, when the discharging to the first load 45 or the like is controlled by the regular mode in a case where both the cartridge 40 and the capsule 50 are of the menthol type, the unit supply menthol amount of menthol that can be supplied to the user in the first period Tm1 is reduced as indicated by the unit supply menthol amount 131a and the unit supply menthol amount 132a, as compared with a case where the discharging to the first load 45 or the like is controlled by the menthol mode. Therefore, in this way, a sufficient amount of menthol may not be supplied to the user in the first period Tm1.

On the other hand, in the menthol mode in a case where both the cartridge 40 and the capsule 50 are of the menthol type, the MCU 63 sets the second load 34 (that is, the flavor source 52) to have a high temperature in the vicinity of 80 [° C.] in the first period Tm1 which is assumed to be a period before the flavor source 52 (specifically, the cigarette granules 521) and the menthol reach the adsorption equilibrium state. Accordingly, in the first period Tm1, the MCU 63 can prompt the flavor source 52 (specifically, the cigarette granules 521) and the menthol to reach the adsorption equilibrium state at an early stage in the capsule 50, and can prevent the menthol derived from the aerosol source 71 from being adsorbed to the flavor source 52, and can ensure an amount of the menthol to be supplied to the mouth of the user avoiding the menthol being adsorbed to the flavor source 52 among the menthol derived from the aerosol source 71. Further, the MCU 63 can increase the menthol derived from the flavor source 52, which is desorbed from the flavor source 52 (specifically, the cigarette granules 521) and is to be supplied to the mouth of the user by setting the second load 34 (that is, the flavor source 52) to have a high temperature in the first period Tm1. Therefore, a sufficient amount of menthol can be supplied to the user from a period when the flavor component contained in the flavor source 52 is sufficient (new product time), as indicated by the unit supply menthol amount 131a.

In part (c) of FIG. 13, a unit supply menthol amount 133a is an example of a unit supply menthol amount in a case where both the cartridge 40 and the capsule 50 are of the menthol type and the flavor source 52 is not heated by the second load 34. In this case, the temperature of the second load 34 (that is, the flavor source 52) in the first period Tm1 is the room temperature (see R.T. in part (c) of FIG. 13). Therefore, in this case, since the temperature of the flavor source 52 in the first period Tm1 is lower than that in a case where the discharging to the first load 45 or the like is controlled by the menthol mode, a sufficient amount of menthol cannot be supplied to the user in the first period Tm1, as indicated by the unit supply menthol amount 133a.

In order to supply a sufficient amount of menthol to the user in the first period Tm1, the target temperature of the second load 34 in the first period Tm1 is set to be high in the menthol mode. However, when the flavor source 52 heated to a high temperature in the first period Tm1 is also continuously heated at a high temperature in the second period Tm2, a large amount of menthol is supplied to the user, which may lead to a decrease in flavor.

Therefore, as described above, in the menthol mode, the target temperature of the second load 34 in the second period Tm2 is set to be lower than the target temperature of the second load 34 in the first period Tm1, so that the flavor source 52 that is heated to a high temperature in the first period Tm1 is prevented from being continued to be heated at a high temperature in the second period Tm2. Accordingly, as indicated by the unit supply menthol amount 131a, in the second period Tm2 which is assumed to be a period after the flavor source 52 (specifically, the cigarette granules 521) and the menthol reach the adsorption equilibrium state, by lowering the temperature of the flavor source 52, an amount of the menthol that can be adsorbed to the flavor source 52 (specifically, the cigarette granules 521) can be increased, and the unit supply menthol amount can be prevented from increasing. Therefore, it is possible to supply an appropriate amount of menthol to the user in the second period Tm2.

In order to prevent a large amount of menthol from being supplied to the user in the second period Tm2, the target temperature of the second load 34 in the second period Tm2 is set to be low in the menthol mode. However, when the target temperature of the second load 34 is set to be low in this manner, it is possible to prevent an increase in the unit supply menthol amount in the second period Tm2, but it is considered that the unit supply flavor component amount in the second period Tm2 also decreases, and it is not possible to provide a sufficient inhalation feeling to the user.

Therefore, in the menthol mode in a case where both the cartridge 40 and the capsule 50 are of the menthol type, that is, the aerosol source 71 and the flavor source 52 contain menthol, the MCU 63 sets the voltage applied to the first load 45 in the first period Tm1 to V1 [V], and sets the voltage applied to the first load 45 in the second period Tm2 after the first period Tm1 to V2 [V] which is higher than V1 [V]. Accordingly, the voltage applied to the first load 45 can be changed to V2 [V] which is high in accordance with the period becoming the second period Tm2 and the target temperature of the second load 34 being changed to 60 [° C.] which is low. Therefore, an amount of the aerosol source 71 that is generated by being heated with the first load 45 and is supplied to the flavor source 52 can be increased in the second period Tm2, and the unit supply flavor component amount in the second period Tm2 can be prevented from decreasing as indicated by the unit supply flavor component amount 131b.

(Specific Control Example when Only Cartridge 40 is of Menthol Type)

Next, a specific control example of the MCU 63 when only the cartridge 40 is of the menthol type will be described with reference to FIG. 14. In the menthol mode in a case where only the cartridge 40 is of the menthol type, only the voltage applied to the first load 45 in the first period Tm1 and the second period Tm2 is different from that in the menthol mode in a case where both the cartridge 40 and the capsule 50 are of the menthol type. Therefore, in the following description, portions different from those described with reference to FIG. 13 will be mainly described, and description of portions similar to those described with reference to FIG. 13 will be omitted as appropriate.

In the menthol mode in a case where only the cartridge 40 is of the menthol type, the MCU 63 sets the voltage applied to the first load 45 in the first period Tm1 to V4 [V] as indicated by a thick solid line in part (b) of FIG. 14. V4 [V] is a voltage higher than V3 [V] as shown in part (b) of FIG. 14, and is a voltage set in advance by a manufacturer of the aerosol inhaler 1. Accordingly, in the first period Tm1 in this case, power corresponding to the applied voltage V3 [V] is supplied from the power supply 61 to the first load 45, and the aerosol source 71 vaporized and/or atomized by an amount corresponding to the power is generated by the first load 45.

In the menthol mode in a case where only the cartridge 40 is of the menthol type, the MCU 63 sets the voltage applied to the first load 45 to V5 [V] in the second period Tm2 after the first period Tm1. As shown in part (b) of FIG. 14, V5 [V] is a voltage higher than V3 [V] and lower than V4 [V]. V5 [V] is set in advance by a manufacturer of the aerosol inhaler 1. For example, the MCU 63 can apply a voltage such as V4 [V] or V5 [V] to the first load 45 by controlling the DC/DC converter 66.

An example of a unit supply menthol amount in a case where only the cartridge 40 is of the menthol type and the MCU 63 controls the target temperature of the second load 34 and the voltage applied to the first load 45 by the menthol mode is indicated by a unit supply menthol amount 141a in part (c) of FIG. 14.

An example of a unit supply flavor component amount in a case where only the cartridge 40 is of the menthol type and the MCU 63 controls the target temperature of the second load 34 and the voltage applied to the first load 45 by the menthol mode is indicated by a unit supply flavor component amount 141b in part (c) of FIG. 14.

An example of a unit supply menthol amount in a case where only the cartridge 40 is of the menthol type and the MCU 63 controls the target temperature of the second load 34 and the voltage applied to the first load 45 by the regular mode is indicated by a unit supply menthol amount 142a in part (c) of FIG. 14.

An example of a unit supply flavor component amount in a case where only the cartridge 40 is of the menthol type and the MCU 63 controls the target temperature of the second load 34 and the voltage applied to the first load 45 by the regular mode is indicated by a unit supply flavor component amount 142b in part (c) of FIG. 14.

An example of a unit supply menthol amount in a case where only the cartridge 40 is of the menthol type and the flavor source 52 is not heated by the second load 34 is indicated by a unit supply menthol amount 143a in part (c) of FIG. 14.

An example of a unit supply flavor component amount in a case where only the cartridge 40 is of the menthol type and the flavor source 52 is not heated by the second load 34 is indicated by a unit supply flavor component amount 143b in part (c) of FIG. 14.

That is, in the menthol mode in a case where only the cartridge 40 is of the menthol type, that is, the flavor source 52 does not contain menthol, the MCU 63 sets the voltage applied to the first load 45 in the first period Tm1 to V4 [V], and sets the voltage applied to the first load 45 in the second period Tm2 after the first period Tm1 to V5 [V] lower than V4 [V]. Accordingly, in the first period Tm1 which is assumed to be a period before the flavor source 52 (specifically, the cigarette granules 521) and the menthol reach the adsorption equilibrium state in the capsule 50, an amount of the aerosol source 71 that is generated by being heated with the first load 45 and is supplied to the flavor source 52 can be increased by applying V4 [V] which is high to the first load 45 (that is, by supplying large power to the first load 45).

Therefore, in the period before the flavor source 52 and the menthol reach the adsorption equilibrium state, it is possible to increase an amount of menthol supplied to the mouth of the user avoiding the menthol being adsorbed to the flavor source 52 among the menthol derived from the aerosol source 71, and it is possible to promote the flavor source 52 and the menthol to reach the adsorption equilibrium state at an early stage in the capsule 50. Therefore, it is possible to stably supply an appropriate and sufficient amount of menthol to the user from a time (for example, a so-called inhalation start) when the flavor component contained in the flavor source 52 is sufficient.

Although an embodiment of the present invention has been described above with reference to the accompanying drawings, it is needless to say that the present invention is not limited to the embodiment. It will be apparent to those skilled in the art that various changes and modifications may be conceived within the scope of the claims, and it is understood that such changes and modifications naturally fall within the technical scope of the present invention. Further, respective constituent elements in the embodiment described above may be combined as desired without departing from the gist of the present invention.

For example, in the present embodiment, the MCU 63 estimates the remaining amount of the flavor source 52 based on the number of times of the inhaling operation after the new capsule 50 is attached, but a sensor may be provided in the power supply unit 10 or the capsule 50, the remaining amount of the flavor source 52 may be directly detected by the sensor, and the MCU 63 may acquire the remaining amount of the flavor source 52 detected by the sensor.

In addition, for example, in the present embodiment, the MCU 63 estimates that the remaining amount of the aerosol source 71 of the cartridge 40 is equal to or greater than the amount necessary for making the remaining amount of the flavor source 52 that is not used equal to or less than the threshold when the number of times of replacement of the capsule 50 after replacement of the cartridge 40 is not a predetermined number of times (five times in the present embodiment), and estimates that the remaining amount of the aerosol source 71 of the cartridge 40 is less than the amount necessary for making the remaining amount of the flavor source 52 that is not used equal to or less than the threshold when the number of times of replacement of the capsule 50 after replacement of the cartridge 40 is a predetermined number of times (five times in the present embodiment). Alternatively, a sensor may be provided in the power supply unit 10 or the cartridge 40, the remaining amount of the aerosol source 71 may be directly detected by the sensor, and the MCU 63 may acquire the remaining amount of the aerosol source 71 detected by the sensor.

For example, although the heating chamber 43 of the cartridge 40 and the accommodation chamber 53 of the capsule 50 are arranged physically separated from each other and communicate with each other through the aerosol flow path 90 in the present embodiment, the heating chamber 43 and the accommodation chamber 53 may not necessarily be arranged physically separated from each other. The heating chamber 43 and the accommodation chamber 53 may be thermally insulated from each other and may be in communication with each other. In this case, the heating chamber 43 and the accommodation chamber 53 are also thermally insulated from each other, and thus it is possible to make the accommodation chamber 53 less likely to be affected by heat from the first load 45 of the heating chamber 43. Accordingly, rapid desorption of menthol from the flavor source 52 is prevented, and thus menthol can be stably supplied to the user. In addition, the heating chamber 43 and the accommodation chamber 53 may be disposed to be physically separated from each other, may be thermally insulated from each other, and may be in communication with each other.

For example, an overall shape of the aerosol inhaler 1 is not limited to a shape in which the power supply unit 10, the cartridge 40, and the capsule 50 are arranged in a line as shown in FIG. 1. The aerosol inhaler 1 may be implemented such that the cartridge 40 and the capsule 50 can be replaced with respect to the power supply unit 10, and may adopt any shape such as a substantially box shape.

For example, the cartridge 40 may be integrated with the power supply unit 10.

For example, the capsule 50 may be implemented to be replaceable with respect to the power supply unit 10, and may be attachable to and detachable from the power supply unit 10.

For example, in the present embodiment, the first load 45 and the second load 34 are heaters that generate heat by a power discharged from the power supply 61, but the first load 45 and the second load 34 may be Peltier elements that can perform both heat generating and cooling by the power discharged from the power supply 61. When the first load 45 and the second load 34 are implemented in this way, the degree of freedom in controlling the temperature of the aerosol source 71 and the temperature of the flavor source 52 is improved, and thus the unit flavor amount can be controlled at a higher level.

In addition, for example, according to the present embodiment, the MCU 63 controls the discharging from the power supply 61 to the first load 45 and the second load 34 such that the amount of the flavor component converges to the target amount, but the target amount is not limited to a specific value and may be a range having a certain width.

In addition, for example, according to the present embodiment, the MCU 63 controls the discharging from the power supply 61 to the second load 34 such that the temperature of the flavor source 52 converges to the target temperature, but the target temperature is not limited to a specific value and may be a range having a certain width.

In the present description, at least the following matters are described. Although corresponding constituent elements or the like in the above embodiment are shown in parentheses, the present invention is not limited thereto.

(1) A power supply unit (the power supply unit 10) for an aerosol generation device (the aerosol inhaler 1) includes a first connector (the discharge terminal 12) electrically connectable, in an attachable and detachable manner, to a first load (the first load 45) configured to heat an aerosol source (the aerosol source 71), a second connector (the discharge terminal 17) electrically connectable, in an attachable and detachable manner, to a second load (the second load 34) configured to heat a flavor source (the flavor source 52) capable of imparting a flavor to the aerosol source vaporized and/or atomized by being heated with the first load, a power supply (the power supply 61) electrically connected to the first connector and the second connector, a notification unit (the notification unit 16) configured to notify a user of information, and a controller (the MCU 63). The controller is configured to detect whether the first load is connected to first connector, detect whether the second load is in a state of being capable of heating the flavor source, execute flavor information acquisition processing of acquiring information (for example, flavor type information) on whether the aerosol source and the flavor source contain menthol respectively, control at least one of the notification unit and discharging from the power supply to the first load and the second load based on a result of the flavor information acquisition processing, and execute the flavor information acquisition processing when at least one of a change from a state in which the first load is not connected to the first connector to a state in which the first load is connected to the first connector and a change from a state in which the second load is not capable of heating the flavor source to a state in which the second load is capable of heating the flavor source is detected.

According to (1), the flavor information acquisition processing is executed when at least one of a change from a state in which the first load is not connected to the first connector to a state in which the first load is connected to the first connector and a change from a state in which the second load is not capable of heating the flavor source to a state in which the second load is capable of heating the flavor source is detected. Therefore, when there is a possibility that the flavor type of at least one of the aerosol source and the flavor source is changed, the flavor information acquisition processing can be executed, and thus the power consumption of the power supply consumed by the flavor information acquisition processing can be saved.

(2) The power supply unit for an aerosol generation device according to (1), in which the controller is configured to detect or estimate at least one of a remaining amount of the aerosol source and a remaining amount of the flavor source, when at least one of the remaining amount of the aerosol source and the remaining amount of the flavor source is less than a threshold, notify, by the notification unit, the user that at least one of the remaining amount of the aerosol source and the remaining amount of the flavor source is less than the threshold, and execute the flavor information acquisition processing after notification and before execution of the discharging from the power supply to the first load and the second load.

According to (2), when there is a possibility that the flavor type of at least one of the aerosol source and the flavor source is changed, that is, after the user is notified that at least one of the remaining amount of the aerosol source and the remaining amount of the flavor source is less than the threshold, the flavor information acquisition processing can be executed. Accordingly, it is possible to save the power of the power supply consumed by the flavor information acquisition processing. At the same time, since the power supply unit for the aerosol generation device does not necessarily have to detect replacement of the capsule that accommodates the flavor source or the cartridge that stores the aerosol source, the cost and volume of the power supply unit for the aerosol generation device can be reduced.

(3) The power supply unit for an aerosol generation device according to (1), in which the controller has a plurality of modes for controlling the discharging from the power supply to the first load and the second load, the plurality of modes includes at least a regular mode and a menthol mode, and the controller is configured to operate in the menthol mode when information indicating that the aerosol source contains menthol is acquired and information on whether the flavor source contains menthol is acquired in the flavor information acquisition processing, operate in the regular mode when information indicating that the aerosol source does not contain menthol is acquired and information on whether the flavor source contains menthol is acquired in the flavor information acquisition processing, and operate in the regular mode when information on whether the aerosol source contains menthol is acquired and information on whether the flavor source contains menthol is not acquired in the flavor information acquisition processing.

According to (3), in the flavor information acquisition processing, the controller can acquire information on whether the aerosol source contains menthol, and when information on whether the aerosol source contains the menthol cannot be acquired, the controller operates in the regular mode. Therefore, when the flavor source does not contain menthol, the controller is prevented from controlling the second load in the menthol mode. Accordingly, it is possible to prevent generation of an unintended flavor due to heating, in the menthol mode, on a flavor source containing no menthol and it is possible to stably supply at least a flavor derived from the flavor source to the user.

(4) The power supply unit for an aerosol generation device according to (1), in which the controller has a plurality of modes for controlling the discharging from the power supply to the first load and the second load, the plurality of modes includes at least a regular mode and a menthol mode, and the controller is configured to detect or estimate a remaining amount of the aerosol source and a remaining amount of the flavor source, operate in the menthol mode when information indicating that the aerosol source contains menthol is acquired and information on whether the flavor source contains menthol is acquired in the flavor information acquisition processing, operate in the regular mode when information indicating that the aerosol source does not contain menthol is acquired and information on whether the flavor source contains menthol is acquired in the flavor information acquisition processing, and set a result of the aerosol source in the flavor information acquisition processing to be the same as a result of the previous flavor information acquisition processing in a case in which the detected or estimated remaining amount of the aerosol source is equal to or greater than an amount required to make the remaining amount of a brand-new flavor source equal to or less than a threshold when information on whether the aerosol source contains menthol is not acquired and information on whether the flavor source contains menthol is acquired in the flavor information acquisition processing.

According to (4), even when the flavor type information of the aerosol source cannot be acquired in the flavor type information acquisition processing, the result for the flavor type of the aerosol source can be set to the highly probable flavor type of the aerosol source. Accordingly, it is possible to improve the probability that the controller operates in a mode suitable for the flavor type of the aerosol source.

(5) The power supply unit for an aerosol generation device according to (1) or (4), in which the controller has a plurality of modes for controlling the discharging from the power supply to the first load and the second load, the plurality of modes includes at least a regular mode, a menthol mode, and an error mode, the error mode is a mode for preventing the discharging from the power supply to the second load, and the controller is configured to detect or estimate a remaining amount of the aerosol source and a remaining amount of the flavor source, operate in the menthol mode when information indicating that the aerosol source contains menthol is acquired and information on whether the flavor source contains menthol is acquired in the flavor information acquisition processing, operate in the regular mode when information indicating that the aerosol source does not contain menthol is acquired and information on whether the flavor source contains menthol is acquired in the flavor information acquisition processing, and operate in the error mode in a case in which the detected or estimated remaining amount of the aerosol source is less than an amount required to make the remaining amount of a brand-new flavor source equal to or less than a threshold when information on whether the aerosol source contains menthol is not acquired and information on whether the flavor source contains menthol is acquired in the flavor information acquisition processing.

According to (5), in the flavor information acquisition processing, when the flavor type information of the aerosol source cannot be acquired and cannot be estimated, the controller prevents the heating of the flavor source and heats the aerosol source under the same control as in the regular mode. Accordingly, it is possible to prevent generation of an unintended flavor due to heating of the flavor source.

(6) The power supply unit for an aerosol generation device according to any one of (1) to (5), in which the controller has a plurality of modes for controlling the discharging from the power supply to the first load and the second load, the plurality of modes includes at least a regular mode, a menthol mode, and an error mode, the error mode is a mode for preventing the discharging from the power supply to the second load, and the controller is configured to operate in the menthol mode when information indicating that the aerosol source contains menthol is acquired and information on whether the flavor source contains menthol is acquired in the flavor information acquisition processing, operate in the regular mode when information indicating that the aerosol source does not contain menthol is acquired and information on whether the flavor source contains menthol is acquired in the flavor information acquisition processing, and operate in the error mode when information on whether the aerosol source and the flavor source contain menthol is not acquired in the flavor information acquisition processing.

According to (6), when the information on whether both the aerosol source and the flavor source contain the menthol cannot be acquired in the flavor information acquisition processing, the controller prevents the heating of the flavor source and heats the aerosol source under the same control as in the regular mode. Accordingly, it is possible to prevent generation of an unintended flavor due to heating of the flavor source.

(7) The power supply unit for an aerosol generation device according to (5) or (6), in which control on the discharging from the power supply to the first load in the error mode is the same control as control on the discharging from the power supply to the first load in the regular mode.

According to (7), the control on the discharging from the power supply to the first load in the error mode is the same as the control on the discharging from the power supply to the first load in the regular mode. In addition, since the discharging to the second load is prevented, when the controller is operating in the error mode, it is possible to prevent the generation of an unintended flavor due to the heating of the flavor source. Accordingly, it is possible to stably supply at least a flavor derived from the flavor source to the user.

(8) The power supply unit for an aerosol generation device according to any one of (1) to (7), in which the power supply unit further includes an operation unit (the operation unit 15) configured to be operated by the user. The flavor information acquisition processing includes first flavor information acquisition processing of acquiring information on whether the aerosol source and the flavor source contain menthol upon an operation performed on the operation unit by the user, and second flavor information acquisition processing of acquiring information on whether the aerosol source and the flavor source contain menthol without the operation performed on the operation unit by the user. The second flavor information acquisition processing is executed when the first flavor information acquisition processing is unable to be executed.

According to (8), only when the user does not perform an operation of designating the flavor types of the aerosol source and the flavor source, the controller mainly acquires the flavor type information of the aerosol source and the flavor source. Accordingly, the controller can operate in a mode corresponding to the flavor types of the aerosol source and the flavor source while taking the intention of the user into account.

(9) The power supply unit for an aerosol generation device according to (8), in which in the flavor information acquisition processing, when the operation unit is operated after execution of the second flavor information acquisition processing, the first flavor information acquisition processing is executed, and information on whether the aerosol source and the flavor source contain menthol is acquired based on a result of the first flavor information acquisition processing.

According to (9), the flavor type information based on the operation performed on the operation unit by the user can be preferentially applied to the flavor type information of the aerosol source and the flavor source. Accordingly, it is possible to provide a power supply unit for an aerosol generation device with high marketability in which the intention of the user is further taken into account.

What is claimed is:

1. A power supply unit for an aerosol generation device, comprising:
a first connector electrically connectable, in an attachable and detachable manner, to a first load configured to heat an aerosol source;
a second connector electrically connectable, in an attachable and detachable manner, to a second load configured to heat a flavor source capable of imparting a flavor to the aerosol source vaporized and/or atomized by being heated with the first load;
a power supply electrically connected to the first connector and the second connector;
a notification unit configured to notify a user of information; and
a controller, wherein
the controller is configured to:
detect whether the first load is connected to the first connector;
detect whether the second load is in a state of being capable of heating the flavor source;
execute flavor information acquisition processing of acquiring information on whether the aerosol source and the flavor source contain menthol respectively;
control at least one of the notification unit and discharging from the power supply to the first load and the second load based on a result of the flavor information acquisition processing; and
execute the flavor information acquisition processing when at least one of a change from a state in which the first load is not connected to the first connector to a state in which the first load is connected to the first connector and a change from a state in which the second load is not capable of heating the flavor source to a state in which the second load is capable of heating the flavor source is detected.

2. The power supply unit for an aerosol generation device according to claim 1, wherein
the controller is configured to:
detect or estimate at least one of a remaining amount of the aerosol source and a remaining amount of the flavor source,
when at least one of the remaining amount of the aerosol source and the remaining amount of the flavor source is less than a threshold, notify, by the notification unit, the user that at least one of the remaining amount of the aerosol source and the remaining amount of the flavor source is less than the threshold; and
execute the flavor information acquisition processing after notification and before execution of the discharging from the power supply to the first load and the second load.

3. The power supply unit for an aerosol generation device according to claim 1, wherein
the controller has a plurality of modes for controlling the discharging from the power supply to the first load and the second load,
the plurality of modes includes at least a regular mode and a menthol mode, and
the controller is configured to:
operate in the menthol mode when information indicating that the aerosol source contains menthol is acquired and information on whether the flavor source contains menthol is acquired in the flavor information acquisition processing;
operate in the regular mode when information indicating that the aerosol source does not contain menthol is acquired and information on whether the flavor source contains menthol is acquired in the flavor information acquisition processing; and
operate in the regular mode when information on whether the aerosol source contains menthol is acquired and information on whether the flavor source contains menthol is not acquired in the flavor information acquisition processing.

4. The power supply unit for an aerosol generation device according to claim 1, wherein
the controller has a plurality of modes for controlling the discharging from the power supply to the first load and the second load,
the plurality of modes includes at least a regular mode and a menthol mode, and
the controller is configured to:
detect or estimate a remaining amount of the aerosol source and a remaining amount of the flavor source;
operate in the menthol mode when information indicating that the aerosol source contains menthol is acquired and information on whether the flavor source contains menthol is acquired in the flavor information acquisition processing;
operate in the regular mode when information indicating that the aerosol source does not contain menthol is acquired and information on whether the flavor source contains menthol is acquired in the flavor information acquisition processing; and
set a result of the aerosol source in the flavor information acquisition processing to be the same as a result of the previous flavor information acquisition processing in a case in which the detected or estimated remaining amount of the aerosol source is equal to or greater than an amount required to make the remaining amount of a brand-new flavor source equal to or less than a threshold when information on whether the aerosol source contains menthol is not acquired and information on whether the flavor source contains menthol is acquired in the flavor information acquisition processing.

5. The power supply unit for an aerosol generation device according to claim 1, wherein
the controller has a plurality of modes for controlling the discharging from the power supply to the first load and the second load,
the plurality of modes includes at least a regular mode, a menthol mode, and an error mode,
the error mode is a mode for preventing the discharging from the power supply to the second load, and
the controller is configured to:
detect or estimate a remaining amount of the aerosol source and a remaining amount of the flavor source;
operate in the menthol mode when information indicating that the aerosol source contains menthol is acquired and information on whether the flavor source contains menthol is acquired in the flavor information acquisition processing;
operate in the regular mode when information indicating that the aerosol source does not contain menthol is acquired and information on whether the flavor source contains menthol is acquired in the flavor information acquisition processing; and
operate in the error mode in a case in which the detected or estimated remaining amount of the aerosol source is less than an amount required to make the remaining amount of a brand-new flavor source equal to or less than a threshold when information on whether the aerosol source contains menthol is not acquired and information on whether the flavor source contains menthol is acquired in the flavor information acquisition processing.

6. The power supply unit for an aerosol generation device according to claim 1, wherein
the controller has a plurality of modes for controlling the discharging from the power supply to the first load and the second load,
the plurality of modes includes at least a regular mode, a menthol mode, and an error mode,
the error mode is a mode for preventing the discharging from the power supply to the second load, and
the controller is configured to:
operate in the menthol mode when information indicating that the aerosol source contains menthol is acquired and information on whether the flavor source contains menthol is acquired in the flavor information acquisition processing;
operate in the regular mode when information indicating that the aerosol source does not contain menthol is acquired and information on whether the flavor source contains menthol is acquired in the flavor information acquisition processing; and
operate in the error mode when information on whether the aerosol source and the flavor source contain menthol is not acquired in the flavor information acquisition processing.

7. The power supply unit for an aerosol generation device according to claim 5, wherein
control on the discharging from the power supply to the first load in the error mode is the same control as control on the discharging from the power supply to the first load in the regular mode.

8. The power supply unit for an aerosol generation device according to claim 1, further comprising:
an operation unit configured to be operated by the user, wherein
the flavor information acquisition processing includes:
first flavor information acquisition processing of acquiring information on whether the aerosol source and the flavor source contain menthol upon an operation performed on the operation unit by the user; and
second flavor information acquisition processing of acquiring information on whether the aerosol source and the flavor source contain menthol without the operation performed on the operation unit by the user, and
the second flavor information acquisition processing is executed when the first flavor information acquisition processing is unable to be executed.

9. The power supply unit for an aerosol generation device according to claim 8, wherein
in the flavor information acquisition processing, when the operation unit is operated after execution of the second flavor information acquisition processing, the first flavor information acquisition processing is executed, and information on whether the aerosol source and the flavor source contain menthol is acquired based on a result of the first flavor information acquisition processing.
